(19) United States
(12) Patent Application Publication
(10) Pub. No.: US 2022/0150946 A1
(43) Pub. Date: May 12, 2022

(54) SEARCH SPACE GROUP SWITCHING IN NEXT GENERATION NETWORKS

(71) Applicant: FG Innovation Company Limited, Tuen Mun (HK)

(72) Inventors: HSIN-HSI TSAI, Taipei (TW); CHIA-HSIN LAI, Taipei (TW); MEI-JU SHIH, Taipei (TW)

(21) Appl. No.: 17/507,165

(22) Filed: Oct. 21, 2021

Related U.S. Application Data
(60) Provisional application No. 63/104,461, filed on Oct. 22, 2020.

(51) Int. Cl. H04W 72/12; H04W 76/28; H04W 74/08; H04L 1/18

(52) U.S. Cl. CPC H04W 72/1289; H04L 1/1861; H04W 74/0841; H04W 76/28

(57) ABSTRACT

A method for a UE for power saving is provided. The method receives, from a BS, a configuration for configuring a first SSG and a second SSG. The method switches to the first SSG after receiving an indication from the BS. The method starts monitoring a first set of one or more SS sets associated with the first SSG and stops monitoring a second set of one or more SSSs associated with the second SSG on a PDCCH after the UE switches to the first SSG. The method switches to the second SSG during a time period or after determining that the time period has started. The method starts monitoring the second set of one or more SSSs associated with the second SSG and stops monitoring the first set of one or more SSSs associated with the first SSG on the PDCCH after the UE switches to the second SSG.

### CROSS-REFERENCE TO RELATED APPLICATION(S)

The present application claims the benefit of and priority to U.S. Provisional Patent Application Ser. No. 63/104,461, filed on Oct. 22, 2020, entitled “SEARCH SPACE SWITCHING OPERATIONS,” with Attorney Docket No. US82810, the content of which is hereby incorporated fully by reference herein into the present disclosure.

### FIELD

The present disclosure generally relates to wireless communications, and more particularly, to switching between search space (SS) groups by a user equipment (UE) to reduce physical downlink control channel (PDCCH) monitoring which results in efficiency in power saving.

### BACKGROUND

With the tremendous growth in the number of connected devices and the rapid increase in user/network traffic volume, various efforts have been made to improve different aspects of wireless communication for the next-generation wireless communication system, such as the fifth generation (5G) New Radio (NR), by improving data rate, latency, reliability, and mobility. The 5G NR system is designed to provide flexibility and configurability to optimize the network services and types, accommodating various use cases, such as enhanced Mobile Broadband (eMBB), massive Machine-Type Communication (mMTC), and Ultra-Reliable and Low-Latency Communication (URLLC).

In NR, a search space (SS) or a search space set (SSS) may refer to a particular area in the downlink resource grid where the PDCCH may be carried. Typically, a UE may perform blind decoding throughout the search space areas attempting to find the PDCCH data (e.g., the downlink control information (DCI)). Traditionally, a UE may monitor PDCCH occasions and switch from one search space (or SS set) to another by receiving a corresponding radio resource control (RRC) configuration. If a change to a different SS (or SS set) is deemed to be necessary (e.g., change from an SS (or SS set) with higher density of PDCCH monitoring occasions to another SS (or SS set) with a lower density of PDCCH monitoring occasions, or vice versa), the UE may have to receive the appropriate configuration (e.g., through RRC signaling) first and then switch to the different SS (or SS set). For the purpose of power saving in occasions where data traffic pattern may change dynamically, there is room to define new methods or mechanisms for a UE to dynamically and/or implicitly (e.g., without a need to receive new/updated SS configuration) switch between different SSs (or SS sets) and/or different SS groups (SSGs). For example, the UE may be configured with different SSGs which includes different SSs (or SS sets) in each SSG, then the UE may dynamically (e.g., based on NW indication) and/or implicitly (e.g., based on criteria) switch between different SSGs.

### SUMMARY

The present disclosure is directed to an introduction to methods that may switch an SS group (SSG) by a UE to reduce PDCCH monitoring when power saving is necessary or may switch the SSG by a UE to increase PDCCH monitoring when power saving is not necessary.

In a first aspect of the present disclosure, a method for a UE for power saving is provided. The method receives, from a base station (BS), a configuration for configuring a first search space group (SSG) and a second SSG. The method switches to the first SSG after receiving an indication from the BS. The method starts monitors a first set of one or more SS sets associated with the first SSG and stops monitoring a second set of one or more SSSs associated with the second SSG on a PDCCH after the UE switches to the first SSG. The method switches to the second SSG during a time period or after determining that the time period has started. The method starts monitoring the second set of one or more SSSs associated with the second SSG and stops monitoring the first set of one or more SSSs associated with the first SSG on the PDCCH after the UE switches to the second SSG.

An implementation of the first aspect further includes switching to the first SSG after determining that the time period has ended.

In another implementation of the first aspect, the time period starts when a timer starts and the time period ends when the timer expires.

In another implementation of the first aspect, the timer is a Discontinuous Reception (DRX) timer.

In another implementation of the first aspect, the DRX timer is a DRX retransmission timer or a DRX hybrid automatic repeat request (HARQ) round trip time (RTT) timer.

In another implementation of the first aspect, the DRX timer is a DRX on-duration timer

In another implementation of the first aspect, the timer is defined by a random access (RA) response window.

In another implementation of the first aspect, the timer is an RA contention resolution timer.

In another implementation of the first aspect, wherein the time period starts upon transmitting a signal to the BS.

In another implementation of the first aspect, the signal is a HARQ feedback.

In another implementation of the first aspect, the HARQ feedback is a HARQ-Acknowledgement (ACK) or a HARQ-nonAcknowledgement (NACK).

In another implementation of the first aspect, the signal is transmitted on a physical uplink shared channel (PUSCH) or a physical uplink control channel (PUCCH).

Another implementation of the first aspect further includes switching to the second SSG after transmitting a scheduling request (SR) to the BS on a PUCCH.

Another implementation of the first aspect further includes switching to the second SSG after initiating a random access (RA) procedure, or after determining that the RA procedure is ongoing.

In another implementation of the first aspect, the first SSG is associated with a first group index and the second SSG is associated with a second group index.

In another implementation of the first aspect, the first SSG and the second SSG are configured for a bandwidth part (BWP), a cell, or a group of cells.

In another implementation of the first aspect, an SSS is related to a type 3-PDCCH common search space or a UE-specific search space.

In another implementation of the first aspect, the indication is indicated by one of a downlink control information (DCI) format 0-1, a DCI format 1-1, and a DCI format 2-6.

Another implementation of the first aspect further includes switching to the first SSG after activating a BWP.

In a second aspect, a UE for power saving is provided. The UE includes one or more non-transitory computer-readable media storing computer-executable instructions to switching between search space groups (SSGs). The UE also includes at least one processor coupled to the one or more non-transitory computer-readable media, and configured to execute the computer-executable instructions to receive, from a base station (BS), a configuration for configuring a first search space group (SSG) and a second SSG; switch to the first SSG after receiving an indication from the BS; start monitoring a first set of one or more search space sets (SSSs) associated with the first SSG and stop monitoring a second set of one or more SSSs associated with the second SSG on a physical downlink control channel (PDCCH) after the UE switches to the first SSG; switch to the second SSG during a time period or after determining that the time period has started; and start monitoring the second set of one or more SSSs associated with the second SSG and stop monitoring the first set of one or more SSSs associated with the first SSG on the PDCCH after the UE switches to the second SSG.

### BRIEF DESCRIPTION OF THE DRAWINGS

Aspects of the exemplary disclosure are best understood from the following detailed description when read with the accompanying figures. Various features are not drawn to scale, and dimensions of various features may be arbitrarily increased or reduced for clarity of discussion.

FIG. 1 is a schematic diagram illustrating a discontinuous reception cycle for a UE, according to an example implementation of the present disclosure.

FIG. 2A is a schematic diagram illustrating an explicit search space switching mechanism for a UE, according to an example implementation of the present disclosure.

FIG. 2B is a schematic diagram illustrating an implicit search space switching mechanism for a UE, according to an example implementation of the present disclosure.

FIG. 3 is a schematic diagram illustrating identification of PDCCH monitoring occasions, according to an example implementation of the present disclosure.

FIG. 4 is a schematic diagram illustrating a device control protocol mechanism, according to an example implementation of the present disclosure.

FIG. 5 is a schematic diagram illustrating a search space switching mechanism between different search space groups, according to an example implementation of the present disclosure.

FIG. 6 is a schematic diagram illustrating transmissions of search space switching indications, according to an example implementation of the present disclosure.

FIG. 7 is a flowchart illustrating a method for a UE to switch between different search space groups, according to an example implementation of the present disclosure.

FIG. 8 is a flowchart further illustrating the method of FIG. 7, according to an example implementation of the present disclosure.

FIG. 9 is another flowchart further illustrating the method of FIG. 7, according to an example implementation of the present disclosure.

FIG. 10 is another flowchart further illustrating the method of FIG. 7, according to an example implementation of the present disclosure.

FIG. 11 is another flowchart further illustrating the method of FIG. 7, according to an example implementation of the present disclosure.

FIG. 12 is a block diagram illustrating a node for wireless communication, according to an example implementation of the present disclosure.

### DETAILED DESCRIPTION

The acronyms in the present disclosure are defined as follows and unless otherwise specified, the acronyms have the following meanings:

| Acronym | Full name |
|---|---|
| 3GPP | 3rd Generation Partnership Project |
| 5GC | 5G Core |
| ACK | Acknowledgement |
| ARQ | Automatic Repeat Request |
| BA | Bandwidth Adaptation |
| BFR | Beam Failure Recovery |
| BS | Base Station |
| BWP | Bandwidth Part |
| CA | Carrier Aggregation |
| CBRA | Contention Based Random Access |
| CE | Control Element |
| CFRA | Contention Free Random Access |
| CN | Core Network |
| CORESET | Control Resource Set |
| COT | Channel Occupancy Time |
| C-RNTI | Cell-Radio Network Temporary Identifier |
| CSI | Channel State Information |
| DC | Dual Connectivity |
| DCI | Downlink Control Information |
| DCP | DCI with CRC scrambled by PS-RNTI |
| DL | Downlink |
| DRX | Discontinuous Reception |
| HARQ | Hybrid Automatic Repeat Request |
| IE | Information Element |
| LBT | Listen Before Talk |
| MAC | Medium Access Control |
| MCG | Master Cell Group |
| MIMO | Multiple Input Multiple Output |
| NG-RAN | Next-Generation Radio Access Network |
| NR | New Radio |
| NW | Network |
| PCell | Primary Cell |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical Layer |
| PRACH | Physical Random Access Channel |
| PS | Power Saving |
| PUCCH | Physical Uplink Control Channel |
| PUSCH | Physical Uplink Shared Channel |
| RA | Random Access |
| RACH | Random Access Channel |
| RAN | Radio Access Network |
| RAR | Random Access Response |
| Rel | Release |
| RLC | Radio Link Control |
| RNA | RAN-based Notification Area |
| RNTI | Radio Network Temporary Identifier |
| RRC | Radio Resource Control |
| RRM | Radio Resource Management |
| SCell | Secondary Cell |
| SCG | Secondary Cell Group |
| SCS | Sub Carrier Spacing |
| SDAP | Service Data Adaptation Protocol |
| SDU | Service Data Unit |
| SFN | System Frame Number |
| SI | System Information |
| SR | Scheduling Request |
| SS | Search Space |
| TS | Technical Specification |
| UCI | Uplink Control Information |
| UE | User Equipment |
| UL | Uplink |

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”, which specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Any sentence, paragraph, (sub)-bullet, point, action, behavior, term, alternative, aspect, example, or claim described in the present disclosure may be combined logically, reasonably, and properly to form a specific method. Any sentence, paragraph, (sub)-bullet, point, action, behavior, term, alternative, aspect, example, or claim described in the present disclosure may be implemented independently and separately to form a specific method. Dependency, e.g., “based on”, “more specifically”, “in some implementations”, “in one alternative”, “in one example”, “in one aspect”, or etc., in the present disclosure is just one possible example in which would not restrict the specific method. One aspect of the present disclosure may be used, for example, in a communication, communication equipment (e.g., a mobile telephone apparatus, ad base station apparatus, a wireless LAN apparatus, and/or a sensor device, etc.), and integrated circuit (e.g., a communication chip) and/or a program, etc. According to any sentence, paragraph, (sub)-bullet, point, action, behavior, term, alternative, aspect, example, implementation, or claim described in the present disclosure, “X/Y” may include the meaning of “X or Y”. According to any sentence, paragraph, (sub)-bullet, point, action, behavior, term, alternative, aspect, example, implementation, or claim described in the present disclosure, “X/Y” may also include the meaning of “X and Y”. According to any sentence, paragraph, (sub)-bullet, point, action, behavior, term, alternative, aspect, example, implementation, or claim described in the present disclosure, “X/Y” may also include the meaning of “X and/or Y”.

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station, at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a RAN established by one or more base stations.

It should be noted that, in the present disclosure, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A base station may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, eLTE (evolved LTE, e.g., LTE connected to 5GC), NR (often referred to as 5G), and/or LTE-A Pro. However, the scope of the present disclosure should not be limited to the above-mentioned protocols.

A base station may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The base station may be operable to provide radio coverage to a specific geographical area using a plurality of cells included in the RAN. The BS may support the operations of the cells. Each cell may be operable to provide services to at least one UE within its radio coverage. Specifically, each cell (often referred to as a serving cell) may provide services to serve one or more UEs within its radio coverage (e.g., each cell schedules the Downlink (DL) and optionally Uplink (UL) resources to at least one UE within its radio coverage for DL and optionally UL packet transmission). The BS may communicate with one or more UEs in the radio communication system through the plurality of cells.

A cell may allocate sidelink (SL) resources for supporting Proximity Service (ProSe) or Vehicle to Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

In addition, the terms “system” and “network” herein may be used interchangeably. The term “and/or” herein is only an association relationship for describing associated objects, and represents that three relationships may exist. For example, A and/or B may indicate that: A exists alone, A and B exist at the same time, or B exists alone. In addition, the character “/” herein generally represents that the former and latter associated objects are in an “or” relationship.

As discussed above, the next-generation (e.g., 5G NR) wireless network is envisioned to support more capacity, data, and services. A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG is a set of one or more serving cells including the PCell and zero or more secondary cells. Conversely, the SCG is a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the MR-DC mode, the PCell may belong to the MN. The Primary SCG Cell (PSCell) may be an SCG cell in which the UE performs random access (e.g., when performing the reconfiguration with a sync procedure). In MR-DC, the PSCell may belong to the SN. A Special Cell (SpCell) may be referred to a PCell of the MCG, or a PSCell of the SCG, depending on whether the MAC entity is associated with the MCG or the SCG. Otherwise, the term Special Cell may refer to the PCell. A Special Cell may support a Physical Uplink Control Channel (PUCCH) transmission and contention-based Random Access (CBRA), and may always be activated. Additionally, for a UE in an RRC_CONNECTED state that is not configured with the CA/DC, may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

As described above, the present disclosure provides a mechanism for dynamic search space (SS) switching (or SS group switching) by a UE to efficiently reduce the PDCCH monitoring duration which may result in efficient power saving. The terms “Search Space (SS)”, “SS set (SSS),” and “Search Space group (SSG)” may be interchangeably used above and below and may describe one or more search spaces.

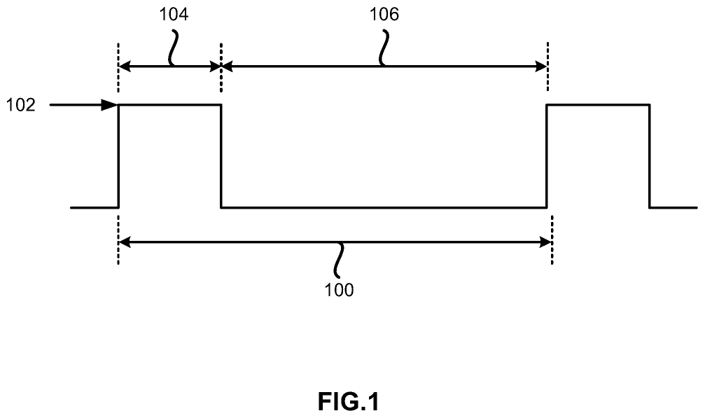

FIG. 1 is a schematic diagram illustrating an example discontinuous reception (DRX) cycle 100 for a UE, according to an example implementation of the present disclosure. PDCCH monitoring cycles 102 may include the times that a UE in a radio resource control (RRC) connected mode may monitor any PDCCH activity which may be governed by DRX, bandwidth allocation (BA), and DCP (downlink control information (DCI) with cyclic redundancy check (CRC) scrambled by power saving radio network temporary identifier (PS-RNTI)), etc.

In some implementations, when the DRX is configured, the UE may not be required to continuously monitor the PDCCH. The DRX may be characterized by at least one of the following factors: a (DRX) on-duration 104, as shown in FIG. 1, a (DRX) inactivity-timer, a (DRX) retransmission-timer, a (DRX) cycle 100 as shown in FIG. 1, and a (DRX) active time 102. The (DRX) on-duration 104 may be a duration for which the UE may wait (e.g., after waking up) to receive PDCCHs. In some implementations, when a UE successfully decodes a PDCCH, the UE may stay awake and may start an (DRX) inactivity timer. The (DRX) inactivity-timer may define a duration in which the UE waits to successfully decode a PDCCH from the last successful decoding of the PDCCH.

In some implementations, failing to decode a PDCCH may put the UE back to an inactivity mode (e.g., sleep mode). In some implementations, the UE may restart the (DRX) inactivity timer following a single successful decoding of a PDCCH for a first transmission only (e.g., not for retransmissions). The (DRX) retransmission-timer may be a duration in which a retransmission may be expected. The (DRX) cycle 100 may be a periodic repetition of the on-duration 104 followed by a possible period of inactivity 106, as shown in FIG. 1. The (DRX) active time 102 may be a total duration that the UE monitors the PDCCH. In some implementations, the total duration may include the “on-duration” 104 of the DRX cycle 100. In some implementations, the UE may perform continuous reception while the (DRX) inactivity timer has not yet expired. In some implementations, the UE may perform continuous reception while waiting for a retransmission opportunity (e.g., when a (DRX) retransmission-timer is running).

In some implementations, when a BA is configured, a UE may only monitor a PDCCH on one active bandwidth part (BWP). In some implementations, the UE may not monitor the PDCCH on the entire DL frequency of a cell. In some implementations, a BWP inactivity timer (e.g., independent from the DRX inactivity-timer described above) may be used to switch the active BWP to the default BWP or the initial BWP. In some implementations, the BWP inactivity timer may be restarted upon a successful PDCCH decoding and the switching to the default BWP or the initial BWP may take place when the timer expires.

In some implementations, if configured, a UE may be indicated, for example, by a DCP that is monitored on an active BWP, whether or not the UE is required to monitor a PDCCH during the next occurrence of an on-duration. In some implementations, when a UE does not detect a DCP on an active BWP, the UE may not monitor a PDCCH during the next occurrence of an on-duration, unless the UE is explicitly configured to do so. In some implementations, a UE may only be configured to monitor a DCP when an RRC connected mode DRX is configured, and at occasion(s) that have a configured offset before the on-duration. More than one monitoring occasions may be configured before the on-duration in some implementations. The UE may not monitor the DCP on occasions, such as during an active-time, measurement gaps, or a BWP switching, in which case the UE may monitor the PDCCH during the next on-duration. In some implementations, if a DCP is not configured in an active BWP, a UE may follow normal DRX operations. In some implementations, when a carrier aggregation (CA) is configured, a DCP may only be configured on a PCell. One DCP may be configured to control PDCCH monitoring during an on-duration for one or more UEs independently.

In some implementations, power saving for a UE in an RRC IDLE mode and/or in an RRC_INACTIVE mode may be achieved by having a UE relax neighboring cells' radio resource management (RRM) measurements, for example, when the UE meets one or more criteria. The one or more criteria may include the UE being in low mobility and/or not being located at a cell edge. In some implementations, UE power saving may be enabled by adapting a DL maximum number of multiple input multiple output (MIMO) layers via BWP switching. In some implementations, power saving may be enabled during an active-time via cross-slot scheduling, which may facilitate the power saving under the assumption that the UE may not be scheduled to receive a PDSCH or may not be triggered to receive an A-CSI or transmit a PUSCH scheduled by a PDCCH until reaching the minimum scheduling offsets (e.g., offsets K0 and K2). In some implementations, dynamic adaptation of the minimum scheduling offsets K0 and K2 may be controlled by a PDCCH.

In some implementations, dynamic SS adaptation may include SS group (SSG) switching in which a UE may be configured to switch between two different types of PDCCH monitoring (e.g., sparse/frequent PDCCH monitoring occasions). In some implementations, the SSG switching may be implemented by other mechanisms, such as an explicit indication, an implicit indication, an implicit condition, and/or by a timer.

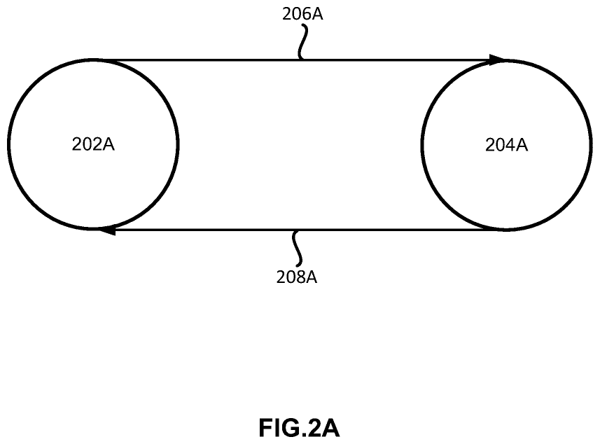

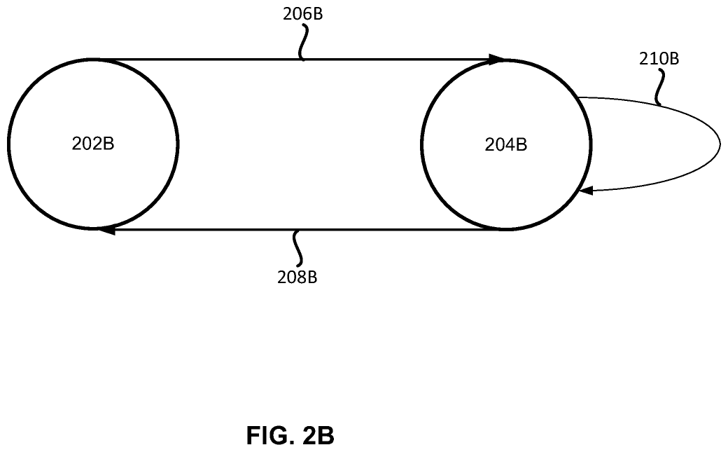

FIG. 2A is a schematic diagram illustrating an explicit SS switching mechanism for a UE, according to an example implementation of the present disclosure. In some implementations, the explicit SS switching of two SSGs may be achieved via a detection of a specific DCI (e.g., DCI format 1_1, DCI format 0_1, DCI format 1-2, DCI format 0-2, DCI format 2_0, DCI format 2_6). A UE may be configured with an RRC parameter for performing the SS (or SSG) switching. In some implementations, a first value (e.g., a bit value of zero “0”) for an SS (or SSG) switching may indicate that only a first SSG (e.g., SSG 202A in FIG. 2A) may be monitored by the UE and a second value (e.g., a bit value of one “1”) for an SS (or SSG) switching may indicate that only a second SSG (e.g., SSG 204A in FIG. 2A) may be monitored. In some implementations, when the DCI is detected and/or the SS switching indication has the second value (e.g., a bit value of “1”), the UE may switch (e.g., 206A in FIG. 2A) from the first SSG 202A to monitor the second SSG 204A and stop monitoring the first SSG 202A. In some implementations, when the DCI is detected and the SS switching indication has the first value (e.g., a bit value of “0”), the UE may switch (e.g., 208A in FIG. 2A) from the second SSG 204A to monitor the first SSG 202A and stop monitoring the second SSG 204A. In some implementations, the UE may start a timer, and upon expiration of the timer, the UE may switch (e.g., 208A in FIG. 2A) to monitor the first SSG 202A and stop monitoring the second SSG 204A.

FIG. 2B is a schematic diagram illustrating an implicit SS (or SSG) switching mechanism for a UE, according to an example implementation of the present disclosure. In some implementations, implicit SS (or SSG) switching may be achieved when the UE is not configured with an RRC parameter. In some implementations, implicit SS switching may be achieved via a DCI and/or a timer as shown in FIG. 2B. In some implementations, when a DCI on an SS associated with a second SSG 204B is detected by the UE, the UE may switch (e.g., 206B in FIG. 2B) from a first SSG 202B to monitor the second SSG 204B and stop monitoring the first SSG 202B. Thereafter, in some implementations, the UE may start a timer, and upon expiration of the timer, the UE may switch (e.g., 208B in FIG. 2B) from the second SSG 204B to monitor the first SSG 202B and stop monitoring the second SSG 204B. In some such implementations, the UE may not switch to SSG 202B (e.g., from SSG 204B) even after detecting any DCI on any SSG, while the timer is running. In these implementations, the UE may switch (e.g., 210B in FIG. 2B) to monitor the second SSG 204B without monitoring the first SSG 202B only after the timer expires.

In some implementations, a timer may be configured for SS (or SSG) switching. In some implementations, the UE may start or restart a timer when a UE detects at least one of: a specific DCI and a SS switching indication set to 1; any DCI on an SS associated with a specific SSG; and/or any DCI on any SS. Upon expiration of the timer, the UE may switch SS monitoring to a first SSG (e.g., to monitor the first SSG and stop monitoring a second SSG). The SS (or SSG) switching by a timer (not explicitly shown) may be applicable to the explicit SS (or SSG) switching and/or the implicit SS (or SSG) switching as shown in FIGS. 2A and 2B.

In some implementations, SS configuration parameters, such as monitoringSlotPeriodicityAndOffset and/or duration in an SS Information Element (IE), may determine the specific slot(s) in the PDCCH that a UE monitors. In some implementations, parameters, such as monitoringSymbolsWithinSlot in SS and duration in ControlResourceSet IE, may determine at least a PDCCH monitoring occasion pattern within a slot.

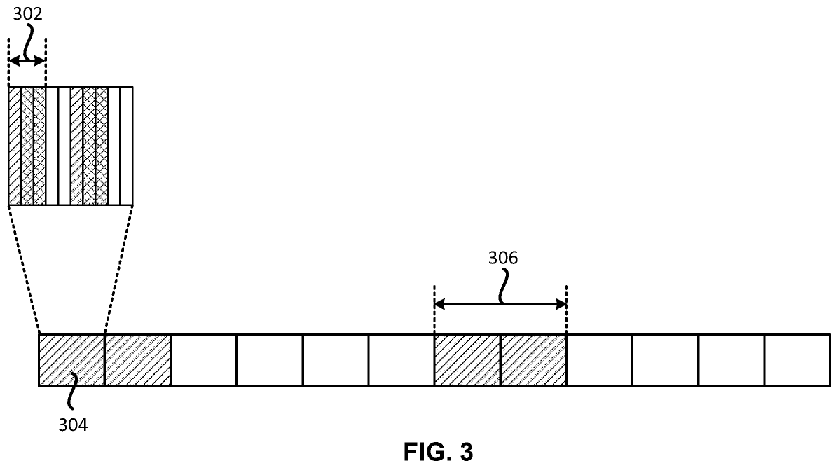

FIG. 3 is a schematic diagram illustrating identification of PDCCH monitoring occasions, according to an example implementation of the present disclosure. In some implementations, the parameter monitoringSymbolsWithinSlot may have a value of “1000010000” and a duration with a value of “3” 302 in a slot 304, as shown in FIG. 3. In some implementations, the parameter monitoringSlotPeriodicityAndOffset may have a value of (s6, 0), indicating a periodicity of “6” and an offset of “0” with a duration with a value of “2” 306, as shown in FIG. 3.

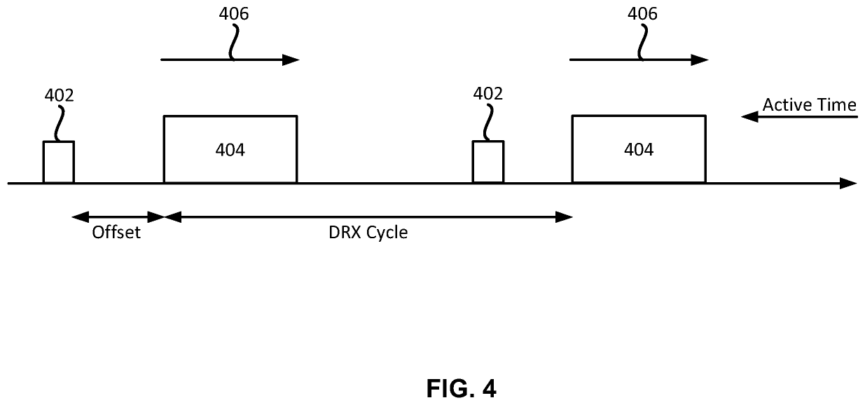

In some implementations, a physical layer signaling may be used to further control PDCCH monitoring behaviors for a DRX on-duration based on a configured DRX mechanism. As such, the NW may send a physical layer signaling to a UE to determine whether or not the UE may wake up within a DRX on-duration (e.g., to start a drx-onDurationTimer for the next DRX cycle or not to start the drx-onDurationTimer for the next DRX cycle). The physical layer signaling may be called a DCP, or a DCI with CRC scrambled by PS-RNTI. FIG. 4 is a schematic diagram illustrating a DCP mechanism, according to an example implementation of the present disclosure. In some implementations, the DCP mechanism in FIG. 4 may be a DCP operation with a wake-up indication. In some implementations, a DCP 402 may be indicated by a DCI format 2_6, which may be used for notifying power saving information outside a DRX Active Time for one or more UEs. In some implementations, the DCI format 2_6 may include a “wake-up indication” (e.g., represented by 1 bit) and a “dormancy indication” (e.g., SCell dormancy indication which may be represented by 0-5 bits). The “wake-up indication” may be used to control PDCCH monitoring behaviors for an on-duration 404 of a DRX via an on-duration timer 406 and the “dormancy indication” may be used to control a BWP switching (e.g., entering or leaving a dormant BWP) for the serving cell(s) corresponding to a dormancy group.

In some implementations, with regards to BWP switching for serving cell(s) of a dormancy group, the NW may group one or more serving cells (e.g., SCells) into a dormancy group and may configure one or more dormancy groups. A dormancy group configuration may be indicated by at least one of the dormancyGroupWithinActiveTime IE and dormancyGroupOutsideActiveTime IE (in ServingCellConfig). The IE dormancyGroupWithinActiveTime or dormancyGroupOutsideActiveTime may contain an identification (ID) of a dormancy group within or outside an active time to which the serving cell may belong. In some implementations, an IE maxNrofDormancyGroups may determine the quantity of groups configured for a Cell Group. In some implementations, when a dormancy group(s) is configured, the NW may switch the BWPs for all the serving cells in the dormancy group(s) entering or leaving a dormant BWP via a signaling (e.g., DCI format 2_6, DCI format 0_1, DCI format 1_1, etc.).

In the above and below descriptions, a UE may include different layers/entities, such as a PHY/MAC/RLC/PDCP/SDAP entity. The PHY/MAC/RLC/PDCP/SDAP entity may be interchangeably referred to as the UE itself. The NW may be a network node, a total radiated power (TRP), a cell (e.g., a SpCell, a PCell, a PSCell, and/or an SCell), an eNB, a gNB, and/or a base station. A serving cell may be one of the PCell, PSCell, and SCell. The serving cell may be an activated or a deactivated serving cell. A SpCell, e.g., for Dual Connectivity operation, may refer to the PCell of the MCG or the PSCell of the SCG depending on whether a MAC entity is associated to the MCG or the SCG, respectively. In some implementations, the SpCell may refer to the PCell.

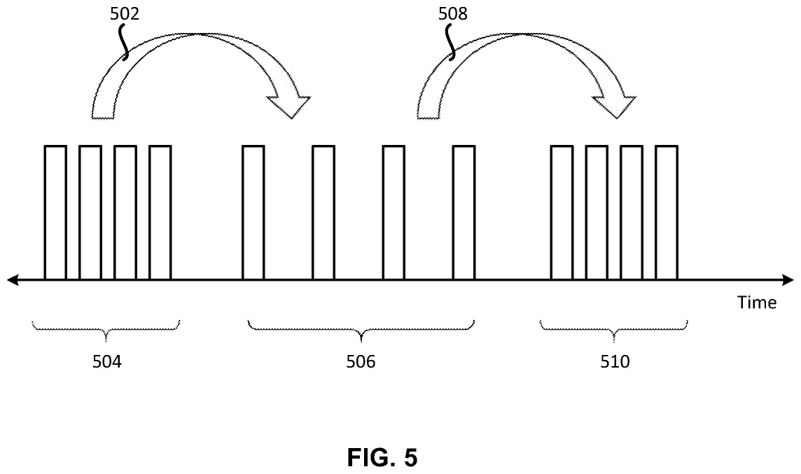

In some implementations, SS switching may be applied to reduce or increase PDCCH monitoring occasions in several possible manners. FIG. 5 is a schematic diagram illustrating SS switching mechanism between different SSGs, according to an example implementation of the present disclosure. In some implementations, an SS switching 502 from a dense SSG 504 (e.g., with dense PDCCH monitoring occasions) to a sparse SSG 506 (e.g., with sparse PDCCH monitoring occasions) or an SS switching 508 from the sparse SSG 506 to another dense SSG 510 (e.g., another group with dense PDCCH monitoring occasions) may be based on different conditions. In some implementations, SSG switching may be achieved by deactivating (or stop monitoring) first SS sets in a first SSG and activating (or start monitoring) second SS sets in a second SSG. In some implementations, PDCCH monitoring of SS sets in an SSG may be performed only when a UE is in a DRX active time. As described in more detail below, a UE may dynamically (e.g., without receiving RRC configuration) switch between the different SSGs 504, 506, and 510 based on the occurrence of one or more (implicit) events.

In some implementations, SSG switching may be applied when a UE receives a specific indication from the NW. In some implementations, SSG switching may be applied based on a timer (e.g., when a particular timer starts or expires). In some implementations, SSG switching may be applied in an implicit way (e.g., when a specific condition is met or satisfied).

In some implementations, SSG switching may be achieved by changing SS configuration and/or CORESET configuration (e.g., monitoringSlotPeriodicityAndOffset, duration, monitoringSymbolsWithinSlot in an IE SearchSpace and/or in an IE ControlResourceSet). In some implementations, if a UE is configured with multiple values for one or more SS/CORESET configuration parameters in a given SS/CORESET configuration or multiple sets of SS/CORESET configuration parameters in the given SS/CORESET configuration, the UE may be indicated (e.g., by a specific indication, by a timer, and/or by an implicit way) which parameter value(s) or which parameter set to apply in order to determine the corresponding PDCCH monitoring occasion(s).

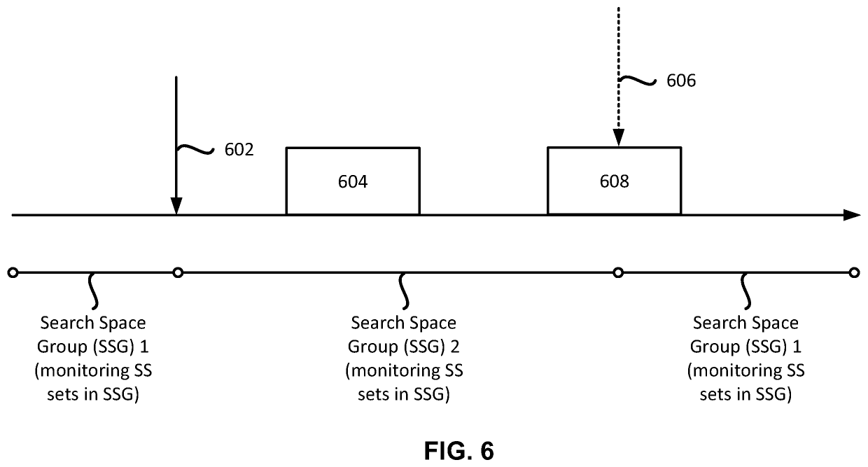

In some implementations, SSG switching may rely on a group-common signaling (e.g., DCI format 2_0) for explicit indication, for example, because shared spectrum channel access and COT sharing may be group common. In some implementations, power saving may be UE-specific, which may highly depend on the individual UE's traffic condition(s) in order to switch the SSG. In some implementations of the present disclosure, a UE-specific indication for SSG switching may enhance the SSG switching mechanism, for example, in occasions where data traffic pattern changes dynamically which may require the UE to dynamically change the SSGs, for example, to better perform power saving. In some implementations, a DCI format 2_6, format 0_1, format 1_1, format 1-2, format 0_2, or other DCI formats may be used. FIG. 6 is a schematic diagram illustrating transmissions of search space group switching indications, according to an example implementation of the present disclosure. In some implementations, with reference to FIG. 6, a DCI (e.g., DCI format 2_6) 602 indicating SSG switching may be transmitted via the NW inside or outside a DRX active time 604. In some implementations, a DCI (e.g., DCI format 0_1 and/or DCI format 1_1) 606 indicating SSG switching may (only) be transmitted via the NW inside a DRX active time 608. In some implementations, a UE-specific indication may be transmitted through a specific RRC signaling, a MAC CE, and/or a PHY layer signaling (e.g., a DCI).

In some implementations of the present disclosure, first SS sets in a first SSG may be a sparse PDCCH monitoring, and second SS sets in a second SSG may be a frequent (or dense) PDCCH monitoring. In some implementations, the first SS sets in the first SSG may also be a dense PDCCH monitoring while the second SS sets in the second SSG may be a sparse PDCCH monitoring. In some implementations, the first SS sets in the first SSG and the second SS sets in the second SSG may be associated with different SS configurations (e.g., indicated by different SS indexes). In some implementations, the first SS sets in the first SSG and the second SS sets in the second SSG may be associated with the same SS configuration but with different parameters, such as different monitoringSlotPeriodicityAndOffset, duration, monitoringSymbolsWithinSlot, etc. In some implementations, the first SS sets in the first SSG and/or the second SS sets in the second SSG may be preconfigured. In some implementations, one of the first SSG and the second SSG may be a default SSG. In some implementations, one of the first SSG and the second SSG may be an SSG specified for power saving purpose (e.g., a power saving SSG, a dormant SSG, and/or an empty SSG). In some implementations, one of the first SSG and the second SSG may be an SSG specified not for power saving (e.g., a default SSG, a normal SSG, a non-dormant SSG, and/or a non-empty SSG). In some implementations, one of the first SSG and the second SSG may be an SSG specified for scheduling purpose. In some implementations, one of the first SSG and the second SSG may include a search space indicated by, such as searchSpaceZero, recoverySearchSpaceId, ra-searchspace, pagingSearchSpace, searchSpaceSIB1, searchSpaceOtherSystemInformation and/or may be a common search space. In some implementations, the first SS sets in the first SSG may (only) include a SS/SSS which is related to USS and/or type-3 CSS types. In some implementations, the second SS sets in the second SSG may (only) include a SS/SSS which is related to USS and/or type-3 CSS types.

In some implementations, if a UE performs an SSG switching to a first SSG, the UE may monitor both the first SS sets in the first SSG and the second SS sets in the second SSG and/or all configured SS sets. In some implementations, if the UE performs an SSG switching to a second SSG, the UE may only monitor second SS sets in the second SSG and stop monitoring first SS sets in a first SSG. In some implementations, if the UE performs an SS switching to a second SSG (e.g., an empty SSG), the UE may not monitor any SS/SSS on a PDCCH. In some implementations, if the UE performs an SS switching to a second SSG (e.g., a dormant SSG), the UE may not monitor some specific SS/SSS on a PDCCH. In some implementations, if the UE performs an SS (or SSG) switching to a second SSG (e.g., a dormant SSG), the UE may only monitor some specific SS/SSS on a PDCCH within a specific time period (e.g., depending on a HARQ (ACK and/or NACK), timers, some events, etc.). In some implementations, when the UE is indicated to monitor SS sets in a SSG on a PDCCH, the UE may only monitor the SS sets in the SSG on the PDCCH during a DRX active time. In some implementations, the UE may not monitor the SS sets in the SSG on the PDCCH outside the DRX active time.

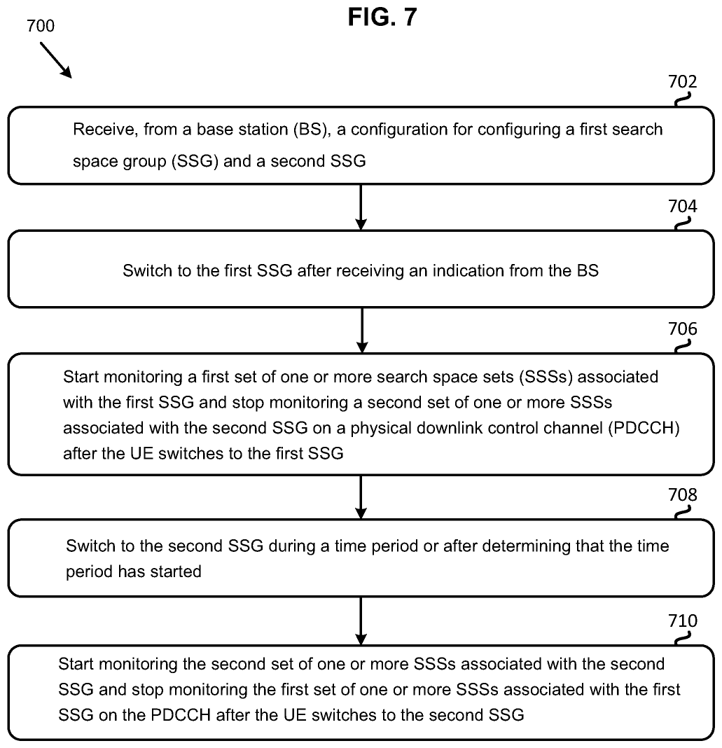

FIG. 7 is a flowchart illustrating a method/process 700 for a UE to switch between different search space groups (SSGs), according to an example implementation of the present disclosure. As illustrated in FIG. 7, process 700 may start by receiving, from a base station (BS), a configuration for configuring a first SSG and a second SSG in action 702. After receiving the configuration, in action 704, process 700 may switch to the first SSG, for example, after receiving an indication from the BS. In action 706, process 700 may start monitoring a first set of one or more search space sets (SSSs) associated with the first SSG and stop monitoring a second set of one or more SSSs associated with the second SSG on a physical downlink control channel (PDCCH) after the UE switches to the first SSG. In action 708, process 700 may switch to the second SSG during a time period or after determining that the time period has started. In action 710, process 700 may start monitoring the second set of one or more SSSs associated with the second SSG and stop monitoring the first set of one or more SSSs associated with the first SSG on the PDCCH after the UE switches to the second SSG.

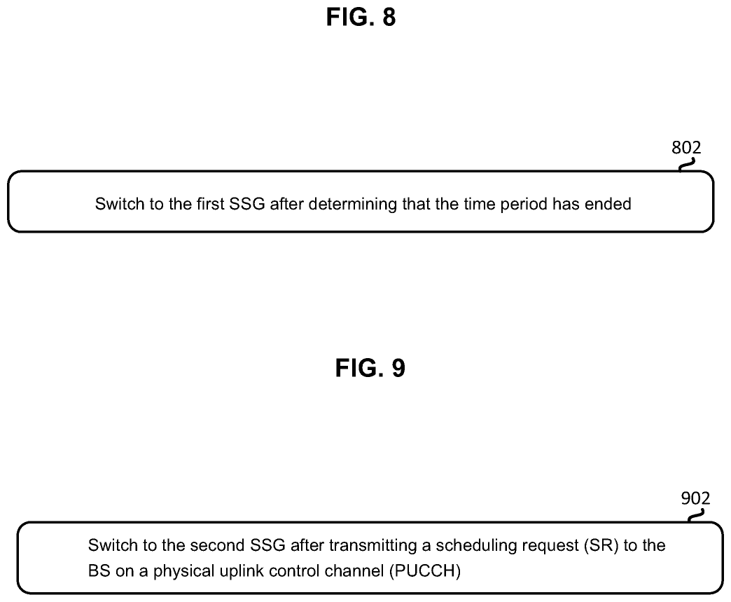

In one or more implementations of the present disclosure, actions 702 to 710 may further include action 802 in FIG. 8, which is a flowchart further illustrating the method of FIG. 7, according to an example implementation of the present disclosure. As illustrated in FIG. 8, action 802 may include switching (back) to the first SSG after determining that the time period has ended.

In one or more implementations of the present disclosure, actions 702 to 710 may further include action 902 in FIG. 9, which is another flowchart further illustrating the method of FIG. 7, according to an example implementation of the present disclosure. As illustrated in FIG. 9, action 902 may include switching to the second SSG after transmitting a scheduling request (SR) to the BS on a physical uplink control channel (PUCCH).

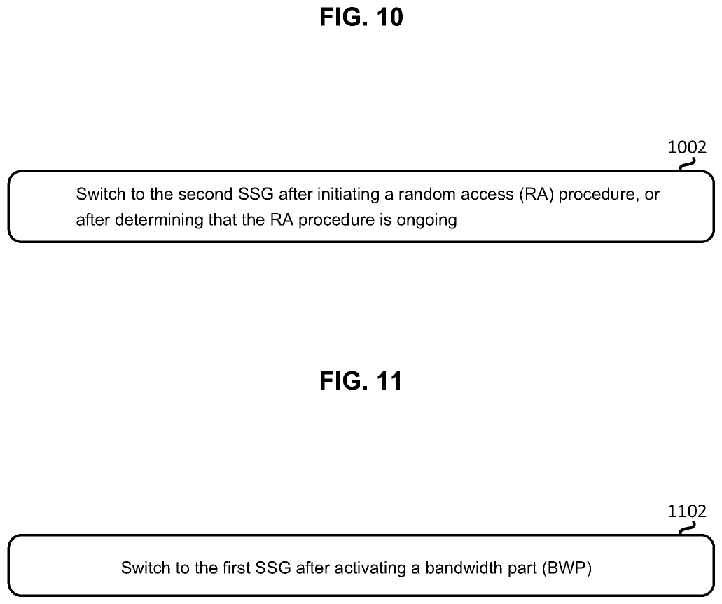

In one or more implementations of the present disclosure, actions 702 to 710 may further include action 1002 in FIG. 10, which is another flowchart further illustrating the method of FIG. 7, according to an example implementation of the present disclosure. As illustrated in FIG. 10, action 1002 may include switching to the second SSG after initiating a random access (RA) procedure, or after determining that the RA procedure is ongoing.

In one or more implementations of the present disclosure, actions 702 to 710 may further include action 1102 in FIG. 11, which is another flowchart further illustrating the method of FIG. 7, according to an example implementation of the present disclosure. As illustrated in FIG. 11, action 1102 may include switching to the first SSG after activating a bandwidth part (BWP).

In some implementations, SSG switching for at least one of a BWP, a serving cell, a group of serving cells, and all serving cells may be controlled by a specific DCI (e.g., DCP with a DCI format 2_6, DCI format 0_1, DCI format 1_1, DCI format 0_2, DCI format 1_2 etc.). In some implementations, a UE may switch to monitor a first SS/SSS in a first SSG and/or a second SS/SSS in a second SSG on a PDCCH based on an indication of the specific DCI. In some implementations, the group of serving cells may refer to one or more of: the set/group of serving cells may be a set/group of cells in a cell group which may be configured by a NW and/or a higher layer/a RRC layer for PDCCH adaptation (e.g., SSG switching and/or PDCCH skipping), for power saving and/or for dormancy (e.g. dormancyGroupWithinActiveTime, and/or dormancyGroupOutsideActiveTime, and/or cellGroupsForSwitch); several cell groups may be configured by a NW and/or a higher layer/a RRC layer (e.g. dormancyGroupWithinActiveTime, and/or dormancyGroupOutsideActiveTime, and/or cellGroupsForSwitch) and a DCI field may indicate which one of the several cell groups is the set/group of serving cells, for example, the DCI field may be a bitmap and each bit of the bitmap may correspond to one of the several cell groups (e.g., a set/group of configured SCells); a sequence of DCI fields may be concatenated into a bitmap, each bit of the bitmap may correspond to a configured cell, and the set/group of serving cells may be indicated by interpreting the sequence of DCI fields; and the set/group of serving cells may be a cell group configured for SCell dormancy, and/or SSSG switching, and/or PDCCH skipping, and/or PDCCH monitoring adaptation.

In some implementations, a field of the specific DCI may be used to (e.g., implicitly) indicate the SSG switching. In some implementations, a wake-up indication of the specific DCI may be used to (e.g., implicitly) indicate the SSG switching. In some implementations, a value of “0” for the wake-up indication bit may (e.g., implicitly) indicate the SSG switching to a first SS/SSS in a first SSG and/or a second SS/SSS in a second SSG on the PDCCH for at least one of the BWP, the serving cell, the group of serving cells, and all serving cells. In some implementations, the value of “0” for the wake-up indication bit may further indicate not to start a drx-onDurationTimer for the next DRX cycle. In some implementations, a value of “1” for the wake-up indication bit may (e.g., implicitly) indicate the SSG switching to the first SS/SSS in the first SSG and/or the second SS/SSS in the second SSG on the PDCCH for at least one of the BWP, the serving cell, the group of serving cells, and all serving cells. In some implementations, the value of “1” for the wake-up indication bit may further indicate to start the drx-onDurationTimer for the next DRX cycle.

In some implementations, a dormancy indication of a specific DCI may be used to (e.g., implicitly) indicate an SSG switching. In some implementations, a value of “0” for a bit of a bitmap may indicate an active DL BWP (e.g., provided by a dormant-BWP) for a UE of each activated serving cell in a corresponding group of configured serving cells. The value of “0” for the bit of the bitmap may further indicate to the UE to switch the SS monitoring to a first SS or SSG and/or a second SS or SSG (e.g., for each activated serving cell in the corresponding group of configured serving cells). In some implementations, a value of “1” for a bit of a bitmap may indicate an active DL BWP (e.g., provided by fir st-non-dormant-BWP-ID-for-DCI-inside-active-time) for a UE of each activated serving cell in a corresponding group of configured serving cells, for example, if a currently active DL BWP is the dormant DL BWP. In some implementations, the value of “1” for the bit of the bitmap may further indicate to the UE to switch the SS monitoring to a first SS or SSG and/or a second SS or SSG (e.g., for each activated serving cell in the corresponding group of configured serving cells).

In some implementations, if SSG switching for at least one of the BWP, the serving cell, the group of serving cells, and all serving cells is controlled by a specific DCI, a period or duration for monitoring of a first SS/SSS in a first SSG and/or a second SS/SSS in a second SSG on a PDCCH may be determined based on certain conditions. In some implementations, when a UE receives a specific DCI for an SSG switching from a first SSG to a second SSG, the UE may apply the SS switching indication on the next DRX cycle. In some implementations, when a UE receives a specific DCI for an SSG switching from a first SSG to a second SSG before a DRX cycle, the UE may stop monitoring the first SSG and start monitoring the second SSG on the DRX cycle. In some implementations, the UE may switch back to the first SSG after the DRX cycle. In some implementations, a number of DRX cycles for an SSG switching may be one or more than one. In some implementations, the number of DRX cycles for an SSG switching may be preconfigured or indicated via the specific DCI.

In some implementations, when a UE receives a specific DCI for an SSG switching from a first SSG to a second SSG, the UE may only apply an SSG switching indication on the next DRX-on duration period (e.g., while a corresponding drx-onduration timer is running). In some implementations, when a UE receives a specific DCI for an SSG switching from a first SSG to a second SSG before a DRX cycle, the UE may stop monitoring the first SSG and start monitoring the second SSG on a DRX on-duration period of a DRX cycle. In some implementations, the UE may switch back to the first SSG after, for example, the end of DRX on-duration period or expiry of the DRX on-duration period. In some implementations, a number of DRX-on duration period for an SSG switching may be one or more than one. In some implementations, the number of DRX cycles for an SSG switching may be preconfigured or indicated via the specific DCI.

In some implementations, a period or duration for monitoring of a first SS/SSS in a first SSG and/or a second SS/SSS in a second SSG on a PDCCH may be preconfigured by a network (e.g., via RRC Signaling/configuration). In some implementations, a period or duration may have a unit in millisecond (ms), second (s), symbol, slot, subframe, system frame, DRX cycle, etc. In some implementations, a UE may monitor, detect, and/or receive a specific DCI (e.g., DCP) only outside a DRX active time. In some implementations, a UE may monitor, detect, and/or receive a specific DCI (e.g., DCI format 0_1 or DCI format 1_1) only within a DRX active time.

In some implementations, SSG switching for at least one of a BWP, a serving cell, a group of serving cells, and all serving cells may be controlled by a DRX mechanism, a timer, and/or a DRX timer. In some implementations, the SSG switching for at least one of the BWP, the serving cell, the group of serving cells, and all serving cells may be based on a DRX cycle. In some implementations, if a short DRX cycle is configured and/or a UE uses the short DRX cycle (e.g., for a DRX group and/or a MAC entity), the UE may perform an SSG switching to a first SSG and/or a second SSG on a PDCCH for at least one of a BWP, a serving cell, a group of serving cells, and all serving cells of a DRX group and/or all serving cells of the UE. In some implementations, if a long DRX cycle is configured and/or a UE uses the long DRX cycle (e.g., for a DRX group and/or a MAC entity), the UE may perform an SSG switching to a first SSG and/or a second SSG on a PDCCH for at least one of a BWP, a serving cell, a group of serving cells, and all serving cells of a DRX group and/or all serving cells of the UE.

In some implementations, if a short DRX cycle is configured and/or a UE uses the short DRX cycle (e.g., for a DRX group and/or a MAC entity), the UE may perform an SSG switching to a first SSG on a PDCCH for at least one of a BWP, a serving cell, a group of serving cells, and all serving cells of a DRX group and/or all serving cells of the UE. In some implementations, if a long DRX cycle is configured and/or a UE uses the long DRX cycle (e.g., for a DRX group and/or a MAC entity), the UE may perform an SSG switching to a second SSG on a PDCCH for at least one of a BWP, a serving cell, a group of serving cells, and all serving cells of a DRX group and/or all serving cells of the UE. In some implementations, an association between a DRX cycle (e.g., a short DRX cycle or a long DRX cycle) and an SSG (e.g., a first SSG, a second SSG, etc.) may be preconfigured or predefined to a UE and/or may be configured to the UE via RRC signaling, a MAC CE, and/or DCI. In some implementations, SSG switching for at least one of a BWP, a serving cell, a group of serving cells, and all serving cells may be based on whether a DRX related timer(s) is running. In some implementations, while at least one of drx-onDurationTimer, drx-Inactivity Timer, drx-RetransmissionTimerDL, drx-Retransmission Timer UL, drx-ShortCycleTimer, drx-HARQ-RTT-TimerDL, drx-HARQ-RTT-TimerUL timers is started/running, a UE may perform an SSG switching to a first SSG on a PDCCH for at least one of a BWP, a serving cell, a group of serving cells, and all serving cells of a DRX group and/or all serving cells, e.g., where the timer(s) is performed on.

In some implementations, the SSG switching for at least one of a BWP, a serving cell, a group of serving cells, and all serving cells may be based on a time period. The time period may be defined by the DRX related timer(s). For example, when the timer is started or restarted, the UE may determine that the time period has started. When the timer expires or is not running, the UE may determine that the time period has ended.

In some implementations, the UE may perform an SSG switching to a second SSG on a PDCCH for at least one of a BWP, a serving cell, a group of serving cells, and all serving cells of a DRX group and/or all serving cells, after determining that the time period has started (e.g., when the timer has started or restarted).

In some implementations, the UE may perform an SSG switching to a first SSG on a PDCCH for at least one of a BWP, a serving cell, a group of serving cells, and all serving cells of a DRX group and/or all serving cells, after determining that the time period has ended (e.g., when the timer expires or is not running).

In some implementations, while at least one of the drx-onDurationTimer, drx-Inactivity Timer, drx-RetransmissionTimerDL, drx-RetransmissionTimerUL, drx-ShortCycle Timer, drx-HARQ-RTT-TimerDL, drx-HARQ-RTT-TimerUL timers is not running (or expires or ends), the UE may perform an SSG switching to a second SSG on a PDCCH for at least one of a BWP, a serving cell, a group of serving cells, and all serving cells of a DRX group and/or all serving cells, e.g., where the timer(s) may be performed on.

In some implementations, the drx-onDurationTimer may define a duration at the beginning of a DRX cycle. The drx-onDurationTimer may be started or restarted when the Short DRX cycle is used for a DRX group, and [(SFN×10)+subframe number]modulo(drx-ShortCycle)=(drx-StartOffset)modulo(drx-ShortCycle). The drx-onDurationTimer may be started or restarted when DCP indication associated with the current DRX cycle received from lower layer indicates to start drx-onDurationTimer. The drx-onDurationTimer may be stopped when a DRX Command MAC CE or a Long DRX Command MAC CE is received.

In some implementations, the drx-RetransmissionTimerDL may define a maximum duration until a DL retransmission is received. The drx-RetransmissionTimerDL may be started or restarted when a drx-HARQ-RTT-TimerDL expires and/or if the data of the corresponding HARQ process were not successfully decoded. The drx-RetransmissionTimerDL may be stopped when a MAC PDU is received in a configured downlink assignment. The drx-RetransmissionTimerDL may be stopped if the PDCCH indicates a DL transmission.

In some implementations, the drx-RetransmissionTimerUL may define the maximum duration until a grant for UL retransmission is received. The drx-RetransmissionTimerUL may be started or restarted if a drx-HARQ-RTT-TimerUL expires. The drx-RetransmissionTimerUL may be stopped if a MAC PDU is transmitted in a configured uplink grant and/or an LBT failure indication is not received from lower layers. The drx-RetransmissionTimerUL may be stopped if the PDCCH indicates a UL transmission. The drx-RetransmissionTimerUL may be stopped if a HARQ process receives downlink feedback information and acknowledgement is indicated.

In some implementations, the drx-HARQ-RTT-TimerDL may define the minimum duration before a DL assignment for a HARQ retransmission is expected by the UE/MAC entity. The drx-HARQ-RTT-TimerDL may be started or restarted if the PDCCH indicates a DL transmission. The drx-HARQ-RTT-TimerDL may be started or restarted if a MAC PDU is received in a configured downlink assignment.

In some implementations, the drx-HARQ-RTT-TimerUL may define the minimum duration before a UL HARQ retransmission grant is expected by the UE/MAC entity. The drx-HARQ-RTT-TimerUL may be started or restarted if the PDCCH indicates a UL transmission. The drx-HARQ-RTT-TimerUL may be started or restarted if a MAC PDU is transmitted in a configured uplink grant and/or an LBT failure indication is not received from lower layers.

In some implementations, the SSG switching for at least one of a BWP, a serving cell, a group of serving cells, and all serving cells may be based on a time period.

In some implementations, the SSG switching for at least one of a BWP, a serving cell, a group of serving cells, and all serving cells may be based on a time period. The time period may be defined by a specific event or by a specific UE behaviors (e.g., HARQ, SR, RA, a transmission, etc.).

In some implementations, the SSG switching for at least one of a BWP, a serving cell, a group of serving cells, and all serving cells may be controlled by a specific event (e.g., a HARQ, a SR, a RA, a transmission, etc.). In some implementations, the SSG switching for at least one of a BWP, a serving cell, a group of serving cells, and all serving cells may be based on a HARQ (e.g., ACK and/or NACK) indication.

In some implementations, when a HARQ (e.g., ACK and/or NACK) indication is sent on a PUCCH, a UE may determinate that the time period has started, and/or may perform an SSG switching to a first SSG and/or a second SSG on the PDCCH for at least one of a BWP, a serving cell, a group of serving cells, and all serving cells of the UE.

In some implementations, when a HARQ (e.g., ACK and/or NACK) indication is received, a UE may determinate that the time period has ended, and/or may perform an SSG switching to a first SSG and/or a second SSG on the PDCCH for at least one of a BWP, a serving cell, a group of serving cells, and all serving cells of the UE.

In some implementations, when a DL transmission is successfully received and/or a UL transmission is successfully transmitted, a UE may determinate that the time period has ended, and/or may perform an SSG switching to a first SSG and/or a second SSG on the PDCCH for at least one of a BWP, a serving cell, a group of serving cells, and all serving cells of the UE.

In some implementations, the SSG switching for at least one of a BWP, a serving cell, a group of serving cells, and all serving cells may be based on an SR event/procedure. In some implementations, when an SR is sent on a PUCCH and is pending, a UE may determinate that the time period has started, and/or may perform an SSG switching to a first SSG and/or a second SSG on the PDCCH for at least one of a BWP, a serving cell, a group of serving cells, and all serving cells of the UE. In some implementations, when a UE receives a response (e.g., an UL grant) from a network in response to an SR sent, the UE may determinate that the time period has ended, and/or may perform an SSG switching to a first SSG and/or a second SSG on a PDCCH for at least one of a BWP, a serving cell, a group of serving cells, and all serving cells of the UE.

In some implementations, SSG switching for at least one of a BWP, a serving cell, a group of serving cells, and all serving cells may be based on an RA event/procedure. In some implementations, if a UE is initiating or performing an RA procedure on (e.g., a serving cell) and/or an RA procedure is ongoing, the UE may determinate that the time period has started, and/or may perform an SS switching to a first SSG and/or a second SSG on a PDCCH (e.g., for the serving cell). In some implementations, if a PDCCH indicating a new transmission and/or retransmission (e.g., addressed to a C-RNTI of a MAC entity) has not been received after successful reception of a Random Access Response (RAR) for an RA Preamble not selected by the MAC entity among the contention-based Random Access Preamble, the UE may determinate that the time period has ended, and/or may perform an SSG switching to a first SSG and/or a second SSG on the PDCCH for at least one of a BWP, a serving cell, a group of serving cells, and all serving cells of the UE.

In some implementations, the SSG switching for at least one of a BWP, a serving cell, a group of serving cells, and all serving cells may be based on a time period. The time period may be defined by a timer for RA (e.g., ra-Response Window, ra-ContentionResolutionTimer, msgB-ResponseWindow). For example, when the timer for RA is started or restarted, the UE may determine that the time period has started. When the timer for RA expires or is not running, the UE may determine that the time period has ended.

In some implementations, if at least one of the timers ra-ResponseWindow, ra-ContentionResolutionTimer, msgB-ResponseWindow is running/, has started or restarted, a UE may determinate that the time period has started, and/or may perform an SSG switching to a first SSG and/or a second SSG on a PDCCH for at least one of a BWP, a serving cell, a group of serving cells, and all serving cells of the UE. In some implementations, the ra-ResponseWindow timer may be configured in a RACH-ConfigCommon parameter and/or a BeamFailureRecoveryConfig parameter. In some implementations, if a UE completes an RA procedure, the UE may determinate that the time period has ended, and/or may perform an SSG switching to a first SSG and/or a second SSG on a PDCCH for at least one of a BWP, a serving cell, a group of serving cells, and all serving cells of the UE. In some implementations, the UE may perform an SSG switching to another SSG which is different from a first SSG before completion of the RA. For example, after or when the UE receives an Msg4/MsgB (e.g., for RA contention resolution), the UE may perform an SSG switching to the first SSG on the PDCCH for at least one of the BWP, the serving cell, the group of serving cells, and all serving cells of the UE. In some implementations, after or when the UE transmits an Msg5 (e.g., RRCSetupComplete, RRCResumeComplete), the UE may determinate that the time period has started, and/or may perform an SSG switching to the first SSG and/or a second SSG on the PDCCH for at least one of the BWP, the serving cell, the group of serving cells, and all serving cells of the UE.

In some implementations of the present disclosure, a UE may ignore SSG switching indication(s) for at least one of a BWP, a serving cell, a group of serving cells, and all serving cells of the UE. In some implementations, a UE may not be expected to receive SSG switching indication(s) for at least one of a BWP, a serving cell, a group of serving cells, and all serving cells of the UE. In some implementations, a UE may ignore SSG switching indication(s) if the UE is performing a specific procedure (e.g., a SR procedure, an RA procedure, a BFR procedure, a LBT recovery procedure, retransmission (e.g., based on a DRX retransmission timer and/or a HARQ ACK/NACK), etc.). In some implementations, a UE may not expect to receive SSG switching indication(s) if the UE is performing the specific procedure. In some implementations, if a UE receives an indication of SSG switching for a serving cell or a group of serving cells while an RA procedure associated with the serving cell(s) is ongoing, the UE may ignore the indication of SSS switching, for example, except for the indication reception for SSS switching addressed to a C-RNTI for a successful RA procedure completion, in which case, the UE may perform an SSS switching. In some implementations, upon reception of an indication for an SSS switching other than a successful contention resolution, if a UE decides to perform an SSS switching, the UE may stop the ongoing RA procedure. In some implementations, a UE may ignore SSG switching indication for a specific SS/SSS (e.g., an RA search space, a paging search space, an BFR search space, a system information search space, not an USS and/or not a type-3 CSS, etc.). In some implementations, the UE may only apply the SSG switching indication for a specific SS/SSS (e.g., an USS and/or a type-3 CSS).

In some implementations, if a UE ignores an indication for SSG switching, the UE may continue with the ongoing RA procedure on the serving cell.

In some implementations, a UE may ignore SSG switching indication(s) if the UE is indicated (e.g., by a serving cell) a wake-up indication and/or a dormancy indication. In some implementations, the UE may not be expected to receive the SSS switching indication if the UE is indicated a wake-up indication and/or a dormancy indication. In some implementations, if a UE receives a specific DCI (e.g., DCP, DCI format 0_1, DCI format 1_1) and the specific DCI includes a wake-up indication and/or a dormancy indication, the UE may ignore the SSG switching indication.

In some implementations, a UE may ignore SSG switching indication(s) if the UE is indicated not to wake up. In some implementations, the UE may not be expected to receive the SSG switching indication if the UE is indicated not to wake up. In some implementations, if the UE receives a DCP, and a value of “0” for a wake-up indication bit is indicated, for example, via a wake-up indication of the DCP, the UE may ignore the SSG switching indication. In some implementations, the SS switching indication may also be included in the DCP. In some implementations, the UE may ignore the SSG switching indication for at least one of the serving cells. In some implementations, if the UE receives a dormancy indication (e.g., via DCP or DCI format 0_1 or DCI format 1_1) to indicate to the UE to switch an active BWP of a serving cell/a group of serving cells to a dormant BWP, the UE may ignore the SSG switching indication. In some implementations, a value of “0” for a bit of a bitmap of the dormancy indication may indicate an active DL BWP, provided by a dormant-BWP, for the UE for each activated serving cell in a corresponding group of configured serving cells. In some implementations, the UE may ignore SSG switching indication(s) for a serving cell and/or group(s) of serving cells. In some implementations, the UE may keep monitoring the same SS/SSS in a SSG if the UE ignores the SSG switching indication. In some implementations, the UE may not switch to monitor another SSG if the UE ignores the SSG switching indication. In some implementations, the UE may switch to monitor a specific SSG, e.g., a pre-configured/default/non-default/normal/dormant/non-dormant/empty/non-empty/power saving SSG, if the UE ignores the SSG switching indication.

In some implementations, a UE may perform an SSG switching based on an explicit indication from an NW, an implicit manner, and/or a timer. However, when a BWP and/or a serving cell is configured and/or activated, the UE may need to determine which SSG to monitor (e.g., upon the BWP and/or the serving cell is activated). In some implementations, when a BWP and/or a serving cell is activated (e.g., before receiving an SSG switching indication), the UE may perform an SSG switching to a first SSG and/or a second SSG, for example, for the serving cell. In some implementations, when a BWP and/or a serving cell is activated (e.g., before receiving an SSG switching indication), the UE may start monitoring a first SS/SSS in a first SSG and stop monitoring a second SS/SSS in a second SSG, for example, for the serving cell. In some implementations, when a BWP and/or a serving cell is activated (e.g., before receiving an SSG switching indication), the UE may start monitoring a second SS/SSS in a second SSG and stop monitoring a first SS/SSS in a first SSG, for example, for the serving cell. In some implementations, when a BWP and/or a serving cell is activated (e.g., before receiving an SSG switching indication), the UE may start monitoring both a first SS/SSS in a first SSG and a second SS/SSS in a second SSG, for example, for the serving cell. In some implementations, when a BWP and/or a serving cell is activated (e.g., before receiving an SSG switching indication), the UE may start monitoring all configured SSs/SSSs (or SSGs), for example, for the serving cell.

In some implementations of the present disclosure, a timer may be introduced to control the UE behavior on SSG switching (e.g., for power saving purposes), which may be a different timer from an SSG switching timer (e.g., configured by an IE searchSpaceSwitchingTimer) introduced in Rel-16 of the 3GPP. In some implementations, an SSG switching timer (e.g., configured by an IE searchSpaceSwitchingTimer) introduced in Rel-16 may be reused (e.g., for power saving purpose). The SSG switching timer introduced in Rel-16 may have the following characteristics:
the SSG switching timer may be configured per serving cell in which a value of the SSG switching timer in slots for monitoring PDCCH in an active DL BWP of a serving cell before switching to the default search space group;
the SSG switching timer is started or restarted when one or more of the following conditions is satisfied:
   the UE detects a DCI and/or the SS switching flag is set to 1;
   the UE detects any DCI on an SS/SSS associated with a first SS group; and
   the UE detects any DCI on any SS/SSS;
upon the SSG switching timer expires, the UE may need to:
   switch the SS/SSS monitoring to the first SS group (e.g., to monitor the first SS group and stop monitoring a second SS group); or
   switch the SS/SSS monitoring to a default SS group (e.g., the first SS group may be the default SS group, the default SS group may be predefined or preconfigured to the UE, and the default SS group may be dynamically configured to the UE via an RRC signaling/MAC CE/DCI).

In some implementations, SSG switching for power saving purposes may be completely different for NR-U purposes to increase possible starting transmission positions from a gNB, thus more PDCCH monitoring occasions may be necessary. Once a gNB-initiated COT is acquired, the monitoring behavior may be similar to NR operating in a licensed band. PDCCH monitoring behavior may be different inside or outside a COT. In order to address such a difference, two groups of PDCCH SS sets may be configured by RRC reconfiguration, for example, one SS/SSS (or SSG) may be for PDCCH monitoring outside COT (e.g., default SS set), and the other SS/SSS (or SSG) may be for PDCCH monitoring inside COT (e.g., non-default SS set). In some implementations, power saving via an SSG switching may decrease PDCCH monitoring occasions if the traffic with respect to the UE is not heavy, which may result in power saving for the UE by minimizing the PDCCH monitoring. In order to address such a difference, two groups of PDCCH SS sets may be configured by RRC configuration or RRC reconfiguration, for example, one SSG may be for sparse PDCCH monitoring (e.g., for power saving), and the other SSG may be for frequent PDCCH monitoring (e.g., not for power saving). In some implementations, the frequent PDCCH monitoring may be set as normal/default PDCCH monitoring. As such, the mechanisms (e.g., configuration, UE behaviors) for SSG switching may be different.

In some implementations of the present disclosure, some characteristics or UE behaviors for a timer for SSG switching and/or the SSG switching timer, e.g., for power saving, may be provided as follows. In some implementations, more than one of the characteristics or UE behaviors may be applied concurrently. In some implementations, a timer and/or an SSG switching timer may be configured per serving cell and/or per group of serving cells. The timer and/or the SSG switching timer may be applied (e.g., start, restart, stop, UE behaviors upon the timer expiry, etc.) per serving cell and/or per group of serving cells. In some implementations, a value of the timer and/or the SSG switching timer may be (in unit of ms, s, symbol, slot, subframe, system frame, DRX cycle, etc.) for monitoring PDCCH in an active DL BWP of the serving cell and/or the group of serving cells before switching to a first and/or a second SSG.

In some implementations, a group of serving cells may be configured by an NW (e.g., via an RRC configuration). In some implementations, the group may be a dormancy group (e.g., configured by dormancyGroupOutsideActiveTime, dormancyGroupWithinActiveTime). In some implementations, the group may be a specific group for power saving (e.g., power saving cell group). In some implementations, the group may be a DRX group (e.g., configured by secondaryDRX-group). In some implementations, the group may be grouped by FR (Frequency Range). For example, all serving cells in a first group may belong to one FR and all serving cells in a second group may belong to another FR. For example, one FR may be above 6 GHz, while another FR may be below 6 GHz. For example, one FR may cover the licensed frequency, another FR may cover unlicensed frequency, while the other FR may cover the dedicated frequency. In some implementations, the group may be an MCG and/or an SCG. In some implementations, an NW may configure the same value for the timer and/or the SSG switching timer for all serving cells of the UE. In some implementations, an NW may configure the same value for a timer and/or the SSG switching timer for all serving cells of the same group.

In some implementations of the present disclosure, a UE may perform an SSGswitching to a first SSG and/or a second SSG) while a timer and/or an SSG switching timer is running. In some implementations, the UE may perform SSG switching to a first SSG and/or a second SSG for a serving cell if the timer and/or the SSG switching timer for the serving cell is running. In some implementations, the UE may perform SSG switching to a first SSG and/or a second SSG for all serving cells corresponding to a group if the timer and/or the SSG switching timer for the group of serving cells is running.

In some implementations, the UE may monitor a first SS/SSS in a first SSG and stop monitoring a second SS/SSS in a second SSG when a timer and/or an SSG switching timer is running. In some implementations, the UE may monitor a first SS/SSS in a first SSG and stop monitoring a second SS/SSS in a second SSG for a serving cell if the timer and/or the SSG switching timer for the serving cell is running. The UE may receive a value of the timer in a PDCCH of the first SS/SSS (or SSG) and/or in a PDCCH of the second SS/SSS (or SSG) when the UE monitors the PDCCH of the first SS/SSS in the first SSG and/or when the UE monitors the PDCCH of the second SS/SSS in the second SSG. The UE may start or restart the timer when the UE receives the value of the timer. In some implementations, the UE may monitor a first SS/SSS in a first SSG and stop monitoring a second SS/SSS in a second SSG for all serving cells corresponding to a group if the timer and/or the SSG switching timer for the group of serving cells is running. The UE may receive a value of the timer in the PDCCH of the first SSG and/or in the PDCCH of the second SSG when the UE monitors the PDCCH of the first SS/SSS in the first SSG and/or when the UE monitors the PDCCH of the second SS/SSS in the second SSG. The UE may start or restart the timer when the UE receives the value of the timer.

In some implementations, the UE may monitor a second SS/SSS in a second SSG and stop monitoring a first SS/SSS in a first SSG when a timer and/or an SSG switching timer is running. In some implementations, the UE may monitor a second SS/SSS in a second SSG and stop monitoring a first SS/SSS in a first SSG for a serving cell if the timer and/or the SSG switching timer for the serving cell is running. The UE may receive a value of the timer in a PDCCH of the first SSG and/or in a PDCCH of the second SSG when the UE monitors the PDCCH of the first SSG and/or when the UE monitors the PDCCH of the second SSG. The UE may start or restart the timer when the UE receives the value of the timer.

In some implementations, the UE may monitor a second SS/SSS in a second SSG and stop monitoring a first SS/SSS in a first SSG for all serving cells corresponding to a group if the timer and/or the SSG switching timer for the group of serving cells is running. The UE may receive the value of the timer in the PDCCH of the first SSG and/or in the PDCCH of the second SSG when the UE monitors the PDCCH of the first SSG and/or when the UE monitors the PDCCH of the second SSG. The UE may start or restart the timer when the UE receives the value of the timer.

In some implementations of the present disclosure, a timer and/or an SS switching timer may be started or restarted when the UE performs an SSG switching to a first SSG. In some implementations, the timer and/or the SSG switching timer for a serving cell and/or a group of serving cells may be started or restarted when the UE performs SSG switching to a first SSG for the serving cell and/or the group of serving cells.

In some implementations, the timer and/or the SS switching timer may be started or restarted when the UE performs an SSG switching to a second SSG. In some implementations, the timer and/or the SSG switching timer for a serving cell and/or a group of serving cells may be started or restarted when the UE performs SSG switching to a second SSG for the serving cell and/or the group of serving cells.

In some implementations, the timer and/or the SS switching timer may be started or restarted when the UE starts monitoring a first SS/SSS in a first SSG and stops monitoring a second SS/SSS in a second SSG. In some implementations, the timer and/or the SSG switching timer for a serving cell and/or a group of serving cells may be started or restarted when the UE starts monitoring a first SS/SSS in a first SSG and stops monitoring a second SS/SSS in a second SSG for the serving cell and/or the group of serving cells.

In some implementations, the timer and/or the SSG switching timer may be started or restarted when the UE starts monitoring a second SS/SSS in a second SSG and stops monitoring a first SS/SSS in a first SSG. In some implementations, the timer and/or the SSG switching timer for a serving cell and/or a group of serving cells may be started or restarted when the UE starts monitoring a second SS/SSS in a second SSG and stops monitoring a first SS/SSS in a first SSG for the serving cell and/or the group of serving cells.

In some implementations, the timer and/or the SS switching timer may be started or restarted when a BWP of a serving cell is activated (e.g., by the UE or by a serving cell). In some implementations, the timer and/or the SSG switching timer for a serving cell may be started or restarted when a BWP of the serving cell is activated.

In some implementations, the timer and/or the SSG switching timer may be started or restarted when an active BWP of a serving cell is set to a dormant BWP (e.g., by the UE). In some implementations, the timer and/or the SSG switching timer for a serving cell may be started or restarted when an active BWP of the serving cell is set to a dormant BWP.

In some implementations, the timer and/or the SSG switching timer may be started or restarted when an active BWP of a serving cell is set to a BWP, which is not a dormant BWP (e.g., by the UE). In some implementations, the timer and/or the SSG switching timer for a serving cell may be started or restarted when an active BWP of the serving cell is set to a BWP, which is not a dormant BWP.

In some implementations, the timer and/or the SSG switching timer may be started or restarted when a serving cell is activated (e.g., by the UE). In some implementations, the timer and/or the SSG switching timer for a serving cell may be started or restarted when the serving cell is activated.

In some implementations, the timer and/or the SSG switching timer may be started or restarted when the UE receives a (DL) signal from an NW. In some implementations, the (DL) signaling may be a DCI, MAC CE, and/or RRC signaling. In some implementations, the (DL) signaling may be received via a PDCCH, and/or a PDSCH. In some implementations, the (DL) signal may be a specific signaling for SSG switching. In some implementations, the (DL) signal may be a specific DCI (e.g., DCP, DCI format 0_1, DCI format 1_1, etc.). In some implementations, the (DL) signal may indicate a new transmission (for DL or UL) on a serving cell. In some implementations, the timer and/or the SSG switching timer for a serving cell and/or a group of serving cells may be started or restarted when the UE receives the (DL) signal on the serving cell and/or the group of serving cells from the NW. In some implementations, the UE may start or restart the timer when the UE receives a value of the timer and/or the SSG switching timer for a serving cell and/or a group of serving cells from the NW (e.g., via RRC signaling, a MAC CE, DCI, etc.).

In some implementations, the timer and/or the SSG switching timer may be started or restarted when the UE transmits a (UL) signal (successfully) to an NW. In some implementations, the (UL) signaling may be a UCI, a MAC CE, a SDU, a PDU, a TB, a HARQ (ACK/NACK), an SR, an RA preamble, a Msg3/MsgA, an UL data, and/or an RRC signaling. In some implementations, the (UL) signaling may be transmitted via a PUCCH, a PRACH, and/or a PUSCH. In some implementations, the timer and/or the SSG switching timer for a serving cell and/or a group of serving cells may be started or restarted when the UE transmits the (UL) signal on the serving cell and/or the group of serving cells to the NW.

In some implementations, the timer and/or the SSG switching timer may be started or restarted when the UE mis-detects a specific DCI (e.g., DCP) for an SSG switching indication. In some implementations, the UE may be configured with a monitoring occasion (e.g., based on a search space and/or a CORESET) for receiving a specific DCI. However, the UE may fail to receive, decode, and/or detect the specific DCI on the monitoring occasion. In some implementations, the timer and/or the SSG switching timer for all serving cells of the UE may be started or restarted when the UE unsuccessfully receives, decodes, and/or detects a specific DCI on the monitoring occasion (for the specific DCI). In some implementations, whether the UE needs to start or restart the timer and/or the SSG switching timer in the above condition may be configured by the NW.

In some implementations, the timer and/or the SSG switching timer for all serving cells of the UE may be started or restarted when the UE does not monitor a specific DCI (e.g., DCP) on monitoring occasions occurring during an active time, during a RAR window, measurement gaps, or a BWP switching. In some implementations, the timer and/or the SSG switching timer for all serving cells of the UE may be started or restarted if the UE does not monitor the specific DCI (e.g., DCP) on monitoring occasions occurring during the active time, during the RAR window, measurement gaps, or BWP switching. In some implementations, whether the UE needs to start or restart the timer and/or the SSG switching timer in the above condition may be configured by the NW.

In some implementations, the timer and/or the SSG switching timer may be started or restarted when the UE receives a wake-up indication (e.g., via DCP, DCI format 0_1, DCI format 1_1). In some implementations, the timer and/or the SS switching timer for all serving cells may be started or restarted when the UE receives the wake-up indication and/or when a value of “0” for the wake-up indication bit is indicated. In some implementations, the timer and/or the SSG switching timer for all serving cells may be started or restarted when the UE receives the wake-up indication and/or when a value of “1” for the wake-up indication bit is indicated.

In some implementations, the timer and/or the SSG switching timer may be started or restarted when the UE receives a dormancy indication (e.g., via DCP, DCI format 0_1, DCI format 1_1). In some implementations, the timer and/or the SSG switching timer for a group of serving cells may be started or restarted when the UE receives a dormancy indication, and/or when a value of “0” for a bit of a bitmap is indicated for each activated serving cell in a corresponding group of configured serving cells. In some implementations, the timer and/or the SSG switching timer for a group of serving cells may be started or restarted when the UE receives a dormancy indication, and/or when a value of “1” for a bit of a bitmap is indicated for each activated serving cell in a corresponding group of configured serving cells.

In some implementations of the present disclosure, a timer and/or an SSG switching timer may be stopped when the UE performs an SSG switching to a first SSG. In some implementations, the timer and/or the SSG switching timer for a serving cell and/or a group of serving cells may be stopped when the UE performs an SSG switching to a first SSG for the serving cell and/or the group of serving cells.

In some implementations, the timer and/or the SSG switching timer may be stopped when the UE performs an SSG switching to a second SSG. In some implementations, the timer and/or the SSG switching timer for a serving cell and/or a group of serving cells may be stopped when the UE performs an SSG switching to a second SSG for the serving cell and/or the group of serving cells.

In some implementations, the timer and/or the SSG switching timer may be stopped when the UE starts monitoring a first SS/SSS in a first SSG and stops monitoring a second SS/SSS in a second SSG. In some implementations, the timer and/or the SSG switching timer for a serving cell and/or a group of serving cells may be stopped when the UE starts monitoring a first SS/SSS in a first SSG and stops monitoring a second SS/SSS in a second SSG for the serving cell and/or the group of serving cells.

In some implementations, the timer and/or the SSG switching timer may be stopped when the UE starts monitoring a second SS/SSS in a second SSG and stops monitoring a first SS/SSS in a first SSG. In some implementations, the timer and/or the SSG switching timer for a serving cell and/or a group of serving cells may be stopped when the UE starts monitoring a second SS/SSS in a second SSG and stops monitoring a first SS/SSS in a first SSG for the serving cell and/or the group of serving cells.

In some implementations, the timer and/or the SSG switching timer may be stopped when a BWP of a serving cell is deactivated (e.g., by the UE). In some implementations, the timer and/or the SSG switching timer for a serving cell may be stopped when a BWP of the serving cell is deactivated.

In some implementations, the timer and/or the SSG switching timer may be stopped when an active BWP of a serving cell is set to a dormant BWP (e.g., by the UE). In some implementations, the timer and/or the SSG switching timer for a serving cell may be stopped when an active BWP of the serving cell is set to a dormant BWP.

In some implementations, the timer and/or the SSG switching timer may be stopped when an active BWP of a serving cell is set to a BWP, which is not a dormant BWP. In some implementations, the timer and/or the SSG switching timer for a serving cell may be stopped when an active BWP of the serving cell is set to a BWP, which is not a dormant BWP.

In some implementations, the timer and/or the SSG switching timer may be stopped when a serving cell is deactivated (e.g., by the UE). In some implementations, the timer and/or the SS switching timer for a serving cell may be stopped when the serving cell is deactivated.

In some implementations, the timer and/or the SSG switching timer may be stopped when the UE receives a (DL) signaling from the NW. In some implementations, the (DL) signaling may be a DCI, a MAC CE, an DL data, a HARQ (ACL/NACK), a Msg2/RAR/MsgB/Msg4, and/or an RRC signaling. In some implementations, the (DL) signaling may be received via a PDCCH or a PDSCH. In some implementations, the (DL) signal may be a specific signaling for an SSG switching. In some implementations, the (DL) signal may be a specific DCI (e.g., DCP, DCI format 0_1, DCI format 1_1, etc.), In some implementations, the (DL) signal may indicate a new transmission (for DL or UL) on a serving cell. In some implementations, the (DL) signal may be a DRX command MAC CE. For example, the timer and/or the SSG switching timer for a serving cell and/or a group of serving cells may be stopped when the UE receives the (DL) signal on the serving cell and/or the group of serving cells from the NW.

In some implementations, the timer and/or the SSG switching timer may be stopped when the UE mis-detects a specific DCI (e.g., DCP) for an SSG switching indication. In some implementations, the UE may be configured with a monitoring occasion (e.g., based on a search space and/or a CORESET) for receiving the specific DCI. However, the UE may fail to receive, decode, and/or detect the specific DCI on the monitoring occasion. In some implementations, the timer and/or the SS switching timer for all serving cells of the UE may be stopped or stopped again when the UE unsuccessfully receives, decodes, and/or detects the specific DCI on the monitoring occasion (e.g., for the specific DCI). In some implementations, whether or not the UE needs to stop the timer and/or the SS switching timer in the above condition may be configured by the NW.

In some implementations, the timer and/or the SSG switching timer may be stopped when the UE does not monitor a specific DCI (e.g., DCP) on occasions occurring during an active time, during a RAR window, measurement gaps, a BWP switching, etc. In some implementations, the timer and/or the SSG switching timer for all serving cells of the UE may be stopped if the UE does not monitor the specific DCI (e.g., DCP) on monitoring occasions occurring during an active time, during a RAR window, measurement gaps, a BWP switching. In some implementations, whether or not the UE needs to start or restart the timer and/or the SSG switching timer in the above condition may be configured by the NW.

In some implementations, the timer and/or the SSG switching timer may be stopped when the UE receives a wake-up indication (e.g., via DCP, DCI format 0_1, DCI format 1_1). In some implementations, the timer and/or the SSG switching timer for all serving cells may be stopped when the UE receives a wake-up indication and/or a value of “0” for the wake-up indication bit is indicated. In some implementations, the timer and/or the SSG switching timer for all serving cells may be stopped when the UE receives a wake-up indication and/or a value of “1” for the wake-up indication bit is indicated.

In some implementations, the timer and/or the SSG switching timer may be stopped when the UE receives a dormancy indication (e.g., via DCP, DCI format 0_1, DCI format 1_1). In some implementations, the timer and/or the SSG switching timer for a group of serving cells may be stopped when the UE receives a dormancy indication, and/or a value of “0” for a bit of a bitmap is indicated for each activated serving cell in a corresponding group of configured serving cells. In some implementations, the timer and/or the SSG switching timer for a group of serving cells may be stopped when the UE receives a dormancy indication, and/or a value of “1” for a bit of a bitmap is indicated for each activated serving cell in a corresponding group of configured serving cells.

In some implementations of the present disclosure, a UE may perform an SSG switching to a first SSG and/or a second SSG) upon a timer and/or an SSG switching timer expires. In some implementations, the UE may perform an SSG switching to a first SSG and/or a second SSG for a serving cell and/or a group of serving cells upon the timer and/or the SSG switching timer for the serving cell and/or the group of serving cells expires. In some implementations, the first SSG and/or the second SSG may be predefined or preconfigured to the UE, e.g., as a default/non-default/normal/dormant/non-dormant/empty/non-empty/power saving SSG). In some implementations, the first SSG and/or the second SSG may be configured to the UE via an RRC signaling, a MAC CE and/or a DCI.

In some implementations, the UE may start monitoring a first SS/SSS in a first SSG and stop monitoring a second SS/SSS in a second SSG upon the timer and/or the SSG switching timer expires. In some implementations, the UE may start monitoring a first SS/SSS in a first SSG and stop monitoring a second SS/SSS in a second SSG for a serving cell and/or a group of serving cells upon the timer and/or the SSG switching timer for the serving cell and/or the group of serving cells expires.

In some implementations, the UE may start monitoring a second SS/SSS in a second SSG and stop monitoring a first SS/SSS in a first SSG upon the timer and/or the SSG switching timer expires. In some implementations, the UE may start monitoring a second SS/SSS in a second SSG and stop monitoring a first SS/SSS in a first SSG for a serving cell and/or a group of serving cells upon the timer and/or the SSG switching timer for the serving cell and/or the group of serving cells expires.

In some implementations, the UE may start monitoring both a first SS/SSS in a first SSG and a second SS/SSS in a second SSG upon the timer and/or the SSG switching timer expires. In some implementations, the UE may start monitoring both a first SS/SSS in a first SSG and a second SS/SSS in a second SSG for a serving cell and/or a group of serving cells upon the timer and/or the SSG switching timer for the serving cell and/or the group of serving cells expires.

In some implementations, the UE may start monitoring all configured SS/SSS (or SSGs) upon the timer and/or the SSG switching timer expires. In some implementations, the UE may start monitoring all configured SS/SSS (or SSGs) for a serving cell and/or a group of serving cells upon the timer and/or the SSG switching timer for the serving cell and/or the group of serving cells expires.

### Search Space Set Group Switching

In some implementations, a UE may be provided a group index for a respective Type3-PDCCH CSS set or a USS set by searchSpaceGroupIdList-r16 for PDCCH monitoring on a serving cell. If the UE is not provided searchSpaceGroupIdList-r16 for a search space set, the following procedures may not be applicable for PDCCH monitoring according to the search space set. In some implementations, if a UE is provided searchSpaceSwitchingGroupList-r16, indicating one or more groups of serving cells, the following procedures may apply to all serving cells within each group; otherwise, the following procedures may apply only to a serving cell for which the UE is provided searchSpaceGroupIdList-r16. In some implementations, when a UE is provided searchSpaceGroupIDList-r16, the UE may reset PDCCH monitoring according to search space sets with a group index 0, if provided by searchSpaceGroupIdList-r16. In some implementations, a UE may be provided by searchSpaceSwitchingDelay-r16 a number of symbols P_{switch} where a minimum value of P_{switch} is provided in Table 10.4-1 for a UE processing capability 1, a UE processing capability 2, and a SCS configuration μ. A UE processing capability 1 for a SCS configuration μ may apply unless the UE indicates support for UE processing capability 2.

TABLE 10.4-1
Minimum value of P_{switch} [symbols]

| | Minimum P_{switch} | Minimum P_{switch} |
|---|---|---|
| | value for | value for |
| | UE processing capability 1 | UE processing capability 2 |
| μ | [symbols] | [symbols] |
| 0 | 25 | 10 |
| 1 | 25 | 12 |
| 2 | 25 | 22 |

In some implementations, a UE may be provided, by searchSpaceSwitchingTimer-r16, a timer value for a serving cell that the UE is provided by the searchSpaceGroupIdList-r16 or, if provided, for a set of serving cells provided by the searchSpaceSwitchingGroupList-r16. The UE may decrement the timer value by one after each slot based on a reference SCS configuration that is the smallest SCS configuration μ among all configured DL BWPs in the serving cell, or in the set of serving cells. The UE may maintain the reference SCS configuration during the timer decrement procedure.

In some implementations, if a UE is provided, by SearchSpaceSwitchTrigger-r16, a location of a search space set group switching flag field for a serving cell in a DCI format 2_0, as described in Clause 11.1.1;
if the UE detects a DCI format 2_0 and a value of the search space set group switching flag field in the DCI format 2_0 is 0, the UE may start monitoring PDCCH according to search space sets with group index 0, and may stop monitoring PDCCH according to search space sets with group index 1, on the serving cell at a first slot that is at least P_{switch} symbols after the last symbol of the PDCCH with the DCI format 2_0;
if the UE detects a DCI format 2_0 and a value of the search space set group switching flag field in the DCI format 2_0 is 1, the UE may start monitoring PDCCH according to search space sets with group index 1, and may stop monitoring PDCCH according to search space sets with group index 0, on the serving cell at a first slot that is at least P_{switch} symbols after the last symbol of the PDCCH with the DCI format 2_0, and the UE may set the timer value to the value provided by searchSpaceSwitchingTimer-r16
if the UE monitors PDCCH on a serving cell according to search space sets with group index 1, the UE may start monitoring PDCCH on the serving cell according to search space sets with group index 0, and may stop monitoring PDCCH according to search space sets with group index 1, on the serving cell at the beginning of the first slot that is at least P_{switch} symbols after a slot where the timer expires or after a last symbol of a remaining channel occupancy duration for the serving cell that is indicated by DCI format 2_0

In some implementations, if a UE is not provided SearchSpaceSwitchTrigger-r16 for a serving cell,
if the UE detects a DCI format by monitoring PDCCH according to a search space set with group index 0, the UE may start monitoring PDCCH according to search space sets with group index 1, and may stop monitoring PDCCH according to search space sets with group index 0, on the serving cell at a first slot that is at least P_{switch} symbols after the last symbol of the PDCCH with the DCI format, the UE may set a timer value to a value provided by searchSpaceSwitchingTimer-r16 if the UE detects a DCI format by monitoring PDCCH in any search space set
if the UE monitors PDCCH on a serving cell according to search space sets with group index 1, the UE may start monitoring PDCCH on the serving cell according to search space sets with group index 0, and may stop monitoring PDCCH according to search space sets with group index 1, on the serving cell at the beginning of the first slot that is at least P_{switch} symbols after a slot where the timer expires or, if the UE is provided a search space set to monitor PDCCH for detecting a DCI format 2_0, after a last symbol of a remaining channel occupancy duration for the serving cell that is indicated by DCI format 2_0

In some implementations, a UE may determine a slot and a symbol in the slot to start or stop PDCCH monitoring according to search space sets for a serving cell where the UE is provided searchSpaceGroupIdList-r16 or, if searchSpaceSwitchingGroupList-r16 is provided, for a set of serving cells, and based on the smallest SCS configuration μ among all configured DL BWPs in the serving cell or in the set of serving cells and, if any, in the serving cell where the UE receives a PDCCH and detects a corresponding DCI format 2_0 triggering the start or stop of PDCCH monitoring according to search space sets.

### PDCCH Monitoring Indication and Dormancy/Non-Dormancy Behavior for SCells

In some implementations, a UE configured with DRX mode operation [11, TS 38.321] may be provided the following for detection of a DCI format 2_6 in a PDCCH reception on the PCell or on the SpCell [12, TS 38.331]:
a PS-RNTI for DCI format 2_6 byps-RNTI;
a number of search space sets, by dci-Format 2-6, to monitor PDCCH for detection of DCI format 2_6 on the active DL BWP of the PCell or of the SpCell according to a common search space as described in Clause 10.1;
a payload size for DCI format 2_6 by sizeDCI_2-6;
a location in DCI format 2_6 of a wake-up indication bit by psPositionDCI-2-6;
   a value of “0” for a wake-up indication bit, when reported to higher layers, indicates to not start a drx-onDurationTimer for the next long DRX cycle [11, TS 38.321];
   a value of “1” for a wake-up indication bit, when reported to higher layers, indicates to start a drx-onDurationTimer for the next long DRX cycle [11, TS 38.321];
a bitmap, when the UE is provided a number of groups of configured SCells by Scell-groups-for-dormancy-outside-active-time, where;
   the bitmap location is immediately after the wake-up indication bit location;
   the bitmap size is equal to a number of groups of configured SCells where each bit of the bitmap corresponds to a group of configured SCells from the number of groups of configured SCells;
   a value of “0” value for a bit of the bitmap indicates an active DL BWP, provided by a dormant-BWP, for the UE [11, TS38.321] for each activated SCell in a corresponding group of configured SCells;
   a value of “1” for a bit of the bitmap indicates:
      an active DL BWP, provided by first-non-dormant-BWP-ID-for-DCI-outside-active-time, for the UE for each activated SCell in the corresponding group of configured SCells, if a current active DL BWP is the dormant DL BWP;
      a current active DL BWP, for the UE for each activated SCell in the corresponding group of configured SCells, if the current active DL BWP is not the dormant DL BWP;
an offset by ps-Offset indicating a time, where the UE starts monitoring PDCCH for detection of DCI format 2_6 according to the number of search space sets, prior to a slot where the drx-onDurationTimer would start on the PCell or on the SpCell [11, TS 38.321];
for each search space set, the PDCCH monitoring occasions may be the ones in the first Ts slots indicated by duration, or Ts=1 slot if duration is not provided, starting from the first slot of the first T_“s” slots and ending prior to the start of drx-onDurationTimer.

In some implementations, on PDCCH monitoring occasions associated with a same long DRX Cycle, a UE may not expect to detect more than one DCI format 2_6 with different values of the wake-up indication bit for the UE or with different values of the bitmap for the UE. The UE may not monitor PDCCH for detecting DCI format 2_6 during Active Time [11, TS 38.321]. In some implementations, if a UE reports for an active DL BWP a requirement of X slots prior to the beginning of a slot where the UE would start the drx-onDurationTimer, the UE may not be required to monitor PDCCH for detection of DCI format 2_6 during the X slots, where X corresponds to the requirement of the SCS of the active DL BWP in Table 10.3-1.

TABLE 10.3-1
Minimum time gap value X

Minimum Time Gap X (slots)

| SCS (kHz) | Value 1 | Value 2 |
|---|---|---|
| 15 | 1 | 3 |
| 30 | 1 | 6 |
| 60 | 1 | 12 |
| 120 | 2 | 24 |

In some implementations, if a UE is provided search space sets to monitor PDCCH for detection of DCI format 2_6 in the active DL BWP of the PCell or of the SpCell and the UE detects DCI format 2_6, the physical layer of a UE may report the value of the Wake-up indication bit for the UE to higher layers [11, TS 38.321] for the next long DRX cycle.

In some implementations, if a UE is provided search space sets to monitor PDCCH for detection of DCI format 2_6 in the active DL BWP of the PCell or of the SpCell and the UE does not detect DCI format 2_6, the physical layer of the UE may not report a value of the Wake-up indication bit to higher layers for the next long DRX cycle.

In some implementations, if a UE is provided search space sets to monitor PDCCH for detection of DCI format 2_6 in the active DL BWP of the PCell or of the SpCell and the UE:
is not required to monitor PDCCH for detection of DCI format 2_6, as described in Clauses 10, 11.1, 12, and in Clause 5.7 of [11, TS 38.321] for all corresponding PDCCH monitoring occasions outside Active Time prior to a next long DRX cycle; or
does not have any PDCCH monitoring occasions for detection of DCI format 2_6 outside Active Time of a next long DRX cycle;
   the physical layer of the UE may report a value of 1 for the wake-up indication bit to higher layers for the next long DRX cycle.

In some implementations, if a UE is provided search space sets to monitor PDCCH for detection of DCI format 0_1 and DCI format 1_1 and if one or both of DCI format 0_1 and DCI format 1_1 include a SCell dormancy indication field,
the SCell dormancy indication field may a bitmap with size equal to a number of groups of configured SCells, provided by Scell-groups-for-dormancy-within-active-time,
each bit of the bitmap may correspond to a group of configured SCells from the number of groups of configured Scells,
if the UE detects a DCI format 0_1 or a DCI format 1_1 that does not include a carrier indicator field, or detects a DCI format 0_1 or DCI format 1_1 that includes a carrier indicator field with value equal to 0:
a value of “0’ for a bit of the bitmap may indicate an active DL BWP, provided by a dormant-BWP, for the UE for each activated SCell in a corresponding group of configured SCells;
a value of “1” for a bit of the bitmap may indicate:
   an active DL BWP, provided by first-non-dormant-BWP-ID-for-DCI-inside-active-time, for the UE for each activated SCell in the corresponding group of configured SCells, if a current active DL BWP is the dormant DL BWP;
   a current active DL BWP, for the UE for each activated SCell in the corresponding group of configured SCells, if the current active DL BWP is not the dormant DL BWP;
the UE may set the active DL BWP to the indicated active DL BWP.

In some implementations, if a UE is provided search space sets to monitor PDCCH for detection of DCI format 1_1, and if:
the CRC of DCI format 1_1 is scrambled by a C-RNTI or a MCS-C-RNTI, and if
a one-shot HARQ-ACK request field is not present or has a value of “0”, and if
the UE detects a DCI format 1_1 on the primary cell that does not include a carrier indicator field, or detects a DCI format 1_1 on the primary cell that includes a carrier indicator field with a value equal to 0, and if
resourceAllocation=resourceAllocationType0 and all bits of the frequency domain resource assignment field in DCI format 1_1 are equal to 0, or
resourceAllocation=resourceAllocationType1 and all bits of the frequency domain resource assignment field in DCI format 1_1 are equal to 1, or
resourceAllocation=dynamicSwitch and all bits of the frequency domain resource assignment field in DCI format 1_1 are equal to 0 or 1
   the UE may consider the DCI format 1_1 as indicating SCell dormancy, not scheduling a PDSCH reception or indicating a SPS PDSCH release, and for transport block 1 interpret the sequence of fields of modulation and coding scheme, new data indicator, redundancy version and of HARQ process number, antenna port(s), DMRS sequence initialization as providing a bitmap to each configured SCell, in an ascending order of the SCell index. where:
a value of “0” for a bit of the bitmap may indicate an active DL BWP, provided by a dormant-BWP, for the UE for a corresponding activated SCell; and
a value of “1” for a bit of the bitmap may indicate:
   an active DL BWP, provided by first-non-dormant-BWP-ID-for-DCI-inside-active-time, for the UE for a corresponding activated SCell, if a current active DL BWP is the dormant DL BWP; and
   a current active DL BWP, for the UE for a corresponding activated SCell, if the current active DL BWP is not the dormant DL BWP;
the UE may set the active DL BWP to the indicated active DL BWP.

In some implementations, if an active DL BWP provided by a dormant-BWP for a UE on an activated SCell is not a default DL BWP for the UE on the activated SCell, as described in Clause 12, the BWP inactivity timer may not be used for transitioning from the active DL BWP provided by the dormant-BWP to the default DL BWP on the activated SCell.

In some implementations, a UE may be expected to provide HARQ-ACK information in response to a detection of a DCI format 1_1 indicating SCell dormancy after N symbols from the last symbol of a PDCCH providing the DCI format 1_1. In some implementations, if processingType2Enabled of PDSCH-ServingCellConfig is set to enable for the serving cell with the PDCCH providing the DCI format 1_1, N=5 for μ=0, N=5.5 for μ=1, and N=11 for μ=2; otherwise, N=10 for μ=0, N=12 for μ=1, N=22 for μ=2, and N=25 for μ=3, where μ may be the smallest SCS configuration between the SCS configuration of the PDCCH providing the DCI format 1_1 and the SCS configuration of a PUCCH with the HARQ-ACK information in response to the detection of the DCI format 1_1.

### DCI Format 2_6

In some implementations, DCI format 2_6 may be used for notifying power saving information outside a DRX Active Time for one or more UEs. Block number 1, block number 2, . . . , block number N may be transmitted by means of the DCI format 2_6 with CRC scrambled by PS-RNTI, where the starting position of a block is determined by the parameter ps-PositionDCI-2-6 provided by higher layers for the UE configured with the block.

In some implementations, if the UE is configured with higher layer parameter PS-RNTI and dci-Format2-6, one block may be configured for the UE by higher layers, with the following fields defined for the block:
wake-up indication—1 bit
SCell dormancy indication—0 bit if higher layer parameter Scell-groups-for-dormancy-outside-active-time is not configured; otherwise 1, 2, 3, 4 or 5 bits bitmap determined according to higher layer parameter Scell-groups-for-dormancy-outside-active-time, where each bit corresponds to one of the SCell group(s) configured by higher layers parameter Scell-groups-for-dormancy-outside-active-time, with MSB to LSB of the bitmap corresponding to the first to last configured SCell group.

In some implementations, the size of DCI format 2_6 may be indicated by the higher layer parameter sizeDCI-2-6, according to Clause 10.3 of [5, TS 38.213].

### DCI Format 0_1

In some implementations, the DCI format 0_1 may be used for scheduling of one or multiple PUSCH in one cell, or indicating CG downlink feedback information (CG-DFI) to a UE.

### DCI Format 1_1

In some implementations, the DCI format 1_1 may be used for scheduling of PDSCH in one cell.

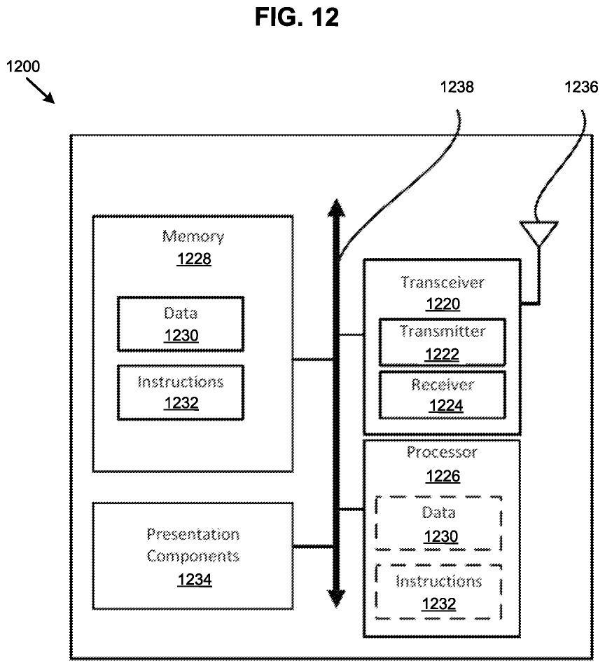

In some implementations of the present disclosure, the method and functions described with reference to FIGS. 1-11 may be implemented in a node. FIG. 12 is a block diagram illustrating a node 1200 for wireless communication, according to one example implementation of the present disclosure. As shown in FIG. 12, the node 1200 may include a transceiver 1220, a processor 1226, a memory 1228, one or more presentation components 1234, and at least one antenna 1236. The node 1200 may also include a Radio Frequency (RF) spectrum band module, a base station communications module, a network communications module, and a system communications management module, input/output (I/O) ports, I/O components, and a power supply (not explicitly shown in FIG. 12) in which each of the components above may be in communication with each other, directly or indirectly, over one or more buses 1238.

The transceiver 1220 may include a transmitter 1222 and a receiver 1224 configured to transmit and/or receive time and/or frequency resource partitioning information. In some implementations, the transceiver 1220 may be configured to transmit in different types of subframes and slots including, but not limited to, usable, non-usable and flexibly usable subframes and slot formats. The transceiver 1220 may be configured to receive data and control signaling.

The node 1200 may include a variety of computer-readable media. Computer-readable media may be any available media accessible by the node 1200 and include both volatile and non-volatile media, removable and non-removable media. By way of example, and not limitation, computer-readable media may include computer storage media and communication media. Computer storage media may include both volatile and non-volatile, removable and non-removable media implemented in any method or technology for storage of information, such as computer-readable instructions, data structures, program modules or other data.

Computer storage media may include RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media do not include a propagated data signal. Communication media may embody computer-readable instructions, data structures, program modules or other data in a modulated data signal such as a carrier wave or other transport mechanism and includes any information delivery media. The term “modulated data signal” may be a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above should also be included within the scope of computer-readable media.

The memory 1228 may include computer-storage media in the form of volatile and/or non-volatile memory. The memory 1228 may be removable, non-removable, or a combination thereof. Exemplary memory may include solid-state memory, hard drives, optical-disc drives, etc. As illustrated in FIG. 12, the memory 1228 may store computer-readable, computer-executable instructions 1232 (e.g., software codes) that are configured to, when executed, cause the processor 1226 to perform various functions described herein, for example, with reference to FIGS. 1 through 12. Alternatively, instructions 1232 may not be directly executable by the processor 1226 but be configured to cause the node 1200 (e.g., when compiled and executed) to perform various functions described herein.

The processor 1226 may include an intelligent hardware device, for example, a central processing unit (CPU), a microcontroller, an ASIC, etc. The processor 1226 may include memory. The processor 1226 may process data 1230 and instructions 1232 received from the memory 1228, and information through the transceiver 1220, the base band communications module, and/or the network communications module. The processor 1226 may also process information to be sent to the transceiver 1220 for transmission through the antenna 1236, and further to the network communications module for transmission to a core network.

The one or more presentation components 1234 may present data indications to a person or other device. For example, the one or more presentation components 1234 may include a display device, speaker, printing component, vibrating component, etc.

From the above description it is manifest that various techniques can be used for implementing the concepts described in the present disclosure without departing from the scope of those concepts. Moreover, while the concepts have been described with specific reference to certain implementations, a person of ordinary skill in the art may recognize that changes can be made in form and detail without departing from the scope of those concepts. As such, the described implementations are to be considered in all respects as illustrative and not restrictive. It should also be understood that the present disclosure is not limited to the particular implementations described above, but many rearrangements, modifications, and substitutions are possible without departing from the scope of the present disclosure.

What is claimed is:

1. A method for a user equipment (UE) for power saving, the method comprising:
receiving, from a base station (BS), a configuration for configuring a first search space group (SSG) and a second SSG;
switching to the first SSG after receiving an indication from the BS;
starting monitoring a first set of one or more search space sets (SSSs) associated with the first SSG and stopping monitoring a second set of one or more SSSs associated with the second SSG on a physical downlink control channel (PDCCH) after the UE switches to the first SSG;
switching to the second SSG during a time period or after determining that the time period has started; and
starting monitoring the second set of one or more SSSs associated with the second SSG and stopping monitoring the first set of one or more SSSs associated with the first SSG on the PDCCH after the UE switches to the second SSG.

2. The method of claim 1, further comprising:
switching to the first SSG after determining that the time period has ended.

3. The method of claim 1, wherein the time period starts when a timer starts and the time period ends when the timer expires.

4. The method of claim 3, wherein the timer is a Discontinuous Reception (DRX) timer.

5. The method of claim 4, wherein the DRX timer is a DRX retransmission timer or a DRX hybrid automatic repeat request (HARQ) round trip time (RTT) timer.

6. The method of claim 4, wherein the DRX timer is a DRX on-duration timer.

7. The method of claim 3, wherein the timer is defined by a random access (RA) response window.

8. The method of claim 3, wherein the timer is an RA contention resolution timer.

9. The method of claim 1, wherein the time period starts upon transmitting a signal to the BS.

10. The method of claim 9, wherein the signal is a HARQ feedback.

11. The method of claim 10, wherein the HARQ feedback is a HARQ-Acknowledgement (ACK) or a HARQ-nonAcknowledgement (NACK).

12. The method of claim 9, wherein the signal is transmitted on a physical uplink shared channel (PUSCH) or a physical uplink control channel (PUCCH).

13. The method of claim 1, further comprising:
switching to the second SSG after transmitting a scheduling request (SR) to the BS on a PUCCH.

14. The method of claim 1, further comprising:
switching to the second SSG after initiating a random access (RA) procedure, or after determining that the RA procedure is ongoing.

15. The method of claim 1, wherein the first SSG is associated with a first group index and the second SSG is associated with a second group index.

16. The method of claim 1, wherein the first SSG and the second SSG are configured for a bandwidth part (BWP), a cell, or a group of cells.

17. The method of claim 1, wherein an SSS is related to a type 3-PDCCH common search space or a UE-specific search space.

18. The method of claim 1, wherein the indication is indicated by one of a downlink control information (DCI) format 0-1, a DCI format 1-1, and a DCI format 2-6.

19. The method of claim 1, further comprising:
switching to the first SSG after activating a BWP.

20. A user equipment (UE) for power saving, comprising:
one or more non-transitory computer-readable media storing computer-executable instructions for switching between search space groups (SSGs); and
at least one processor coupled to the one or more non-transitory computer-readable media, and configured to execute the computer-executable instructions to:
receive, from a base station (BS), a configuration for configuring a first search space group (SSG) and a second SSG;
switch to the first SSG after receiving an indication from the BS;
start monitoring a first set of one or more search space sets (SSSs) associated with the first SSG and stop monitoring a second set of one or more SSSs associated with the second SSG on a physical downlink control channel (PDCCH) after the UE switches to the first SSG;
switch to the second SSG during a time period or after determining that the time period has started; and
start monitoring the second set of one or more SSSs associated with the second SSG and stop monitoring the first set of one or more SSSs associated with the first SSG on the PDCCH after the UE switches to the second SSG.
